(19) United States
(12) Patent Application Publication
(10) Pub. No.: US 2010/0229417 A1
(43) Pub. Date: Sep. 16, 2010

(54) METHOD AND APPARATUS FOR CURING COATED FILM AND OPTICAL FILM

(75) Inventors: Tomonari OGAWA, Fujinomiya-shi (JP); Shuichi ENDO, Fujinomiya-shi (JP); Kazuhiko NOJO, Fujinomiya-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/787,834

(22) Filed: May 26, 2010

Related U.S. Application Data
(62) Division of application No. 11/372,027, filed on Mar. 10, 2006.

(30) Foreign Application Priority Data
Mar. 10, 2005 (JP) 2005067827

(51) Int. Cl. F26B 3/34

(52) U.S. Cl. 34/276

(57) ABSTRACT

The present invention provides a method of curing a coated film which includes irradiating an active ray by a plurality of active ray irradiation devices, wherein the coated film is composed of an active ray-curable resin formed on a surface of a running band-shaped flexible support, including the step of: maintaining the coated film in a deoxidized atmosphere during a period in which the flexible support irradiated with an active ray by the at least one active ray irradiation device is transferred to the active ray irradiation device in a subsequent step.

### CROSS REFERENCE TO RELATED APPLICATIONS

This is a divisional of application Ser. No. 11/372,027 filed Mar. 10, 2006, the disclosure of which is incorporated by reference.

### BACKGROUND OF THE INVENTION

1. Field of the Invention

The present invention relates to a method and an apparatus for curing a coated film and an optical film, and particularly relates to a method and an apparatus for curing a coated film suitable for curing a coated film under a condition of variously controlled oxygen concentrations, and an optical film produced by these.

2. Description of the Related Art

Recently, demand for optical films is increasing. Typical examples of such optical films include optical compensation films used as retardation films in liquid cells, antireflection films and antiglare films, which have various functions. Typical methods of producing such optical films include a method of forming coated films of various compositions, which comprises applying a coating solution to the surface of a band-shaped flexible support (hereinafter referred to as web) using various coating apparatuses, drying and then curing the same. For curing, UV curing devices are often used.

In such a UV curing step, the curing efficiency is important. In particular, it is known that when oxygen is present, it serves as an inhibitor in the polymerization/crosslinking step, reducing the strength of the coated film or weakening bonding between the base material web and the coated film, and finally the hardness and the adhesive strength of the coated film are reduced.

Specifically, a coated film is generally formed by polymerizing low molecular weight resin called monomer by UV light, and oxygen concentration is often set low in the process with this UV irradiation. This is because while radicals generated from an initiator play an important role in polymerization of the resin under UV irradiation, these radicals are consumed when oxygen is present. Thus, it is important to reduce oxygen concentration.

For dealing with this intervening oxygen, various methods and apparatuses have been proposed (see Japanese Patent Application Laid-Open No. 11-104562).

In the above proposal, a construction for removing oxygen by filling the UV irradiation area with inert gas is employed. Specifically, the entire UV irradiation area is covered with a metal member and inert gas is introduced thereinto. It is described that this construction makes it possible to maintain the oxygen concentration in the UV irradiation area at 1000 ppm or lower.

A proposal has also been made concerning production of an optical film having no coating unevenness with controlling generation of rainbow-colored irregularity (color irregularity) upon UV irradiation (see Japanese Patent Application Laid-Open No. 2004-317554). This proposal employs a construction having a plurality of UV irradiation apparatuses, in which a shielding board is placed at a position where UV light is not directly irradiated so as to prevent generation of rainbow-colored irregularity.

### SUMMARY OF THE INVENTION

In the case of an optically functional film (optical film) in which a plurality of coated films are formed on a plastic base material (web), a lower layer is first applied, dried and cured to a sufficient degree, upon which the surface smoothness of the coated film increases due to polymerization/shrinkage as described in Japanese Patent Application Laid-Open No. 11-104562. However, such increase in the surface smoothness of the coated film causes decrease in the interlayer bonding strength between the lower layer and an upper layer coated thereon. As a result, the scratch resistance of the coated film also decreases.

Recently, a plurality of UV irradiation devices have been used for high-speed operation or for achieving higher level properties. At present, however, there is no suitable suggestion as to how to design the shape of casing in order to lower the oxygen concentration in the UV irradiation area. Japanese Patent Application Laid-Open No. 11-104562 proposes an example of a UV irradiation apparatus enclosed in a case together with a backup roll.

On the other hand, as described above, Japanese Patent Application Laid-Open No. 2004-317554 discloses an example of using a plurality of UV irradiation apparatuses, but the device does not have a structure for decreasing the oxygen concentration in the UV irradiation area.

The present invention has been made in view of such circumstances and aims at providing a method and an apparatus for curing a coated film under a condition of variously controlled oxygen concentrations, which can improve the quality of the coated film, particularly, scratch resistance and adhesion, and can greatly improve productivity, and an optical film.

To accomplish the aforementioned object, the present invention provides a method of curing a coated film which includes irradiating an active ray by a plurality of active ray irradiation devices, wherein the coated film is composed of an active ray-curable resin formed on a surface of a running band-shaped flexible support, comprising the step of maintaining the coated film in a deoxidized atmosphere during a period in which the flexible support irradiated with an active ray by the at least one active ray irradiation device is transferred to the active ray irradiation device in a subsequent step.

To accomplish the aforementioned object, the present invention also provides an apparatus for curing a coated film comprising a plurality of active ray irradiation devices which irradiate a coated film formed on a surface of a band-shaped flexible support with an active ray so as to cure the coated film, a device for transferring a support which transfers the flexible support and positions the surface of the flexible support to be faced with an irradiation surface of the active ray irradiation devices in a predetermined distance, and a gas supplying device which supplies inert gas between the irradiation surface and the support, wherein the oxygen concentration between the irradiation surface and the support is controllable to 2% or lower.

According to the present invention, upon curing a coated film by irradiating a coated film comprising an active ray-curable resin formed on a surface of a running band-shaped flexible support with an active ray by a plurality of active ray irradiation devices, the coated film is maintained in a deoxidized atmosphere during a period in which the flexible support irradiated by at least one active ray irradiation device is transferred to the active ray irradiation device of a subsequent step. Therefore, the coated film can be cured under a condition of variously controlled oxygen concentrations and the quality of the coated film, particularly, scratch resistance and adhesion, can be improved, and productivity can be greatly improved.

In the present specification, concentrations of gases such as oxygen concentration are all represented by volume %.

In the present invention, it is preferred that an enclosed space is formed between the plurality of active ray irradiation devices and inert gas is introduced into the enclosed space. Formation of such an enclosed space makes it easier to maintain the coated film in a deoxidized atmosphere.

In the present invention, the oxygen concentration in the enclosed space is controlled to preferably 2% or lower, more preferably 0.5% or lower. Since the oxygen concentration in the enclosed space is controlled to such values, the conditions for curing a coated film can be controlled to the optimal range, and the quality of the coated film, particularly, scratch resistance and adhesion, can be improved. The oxygen concentration is controlled to the range of preferably 0.05 to 0.5%, more preferably 0.02 to 0.4%.

In the present invention, it is preferred that the device which forms the enclosed space is disposed separately from the active ray irradiation devices. When the device which forms the enclosed space is separated from the active ray irradiation devices as described above, influence from the active ray irradiation devices such as heat distortion is small and thus it becomes easier to control the oxygen concentration to the desired range.

In the present invention, it is preferred that the flexible support is put over a roller member to be held at a position where the flexible support is faced with an irradiation surface of the active ray irradiation device. Although any structure may be employed for holding the support, holding as above is suitable for improving the quality of the coated film and reducing the amount of inert gas to be used.

In the present invention, the surface temperature of the roller member is preferably controlled to 30° C. or higher. Further, in the present invention, the temperature of the flexible support is preferably controlled to 40° C. or higher before curing the coated film by active ray irradiation. By controlling the surface temperature of the roller member or the temperature of the flexible support, the speed of curing of the coated film can be increased and oxygen in the boundary layer can be easily removed.

In the present invention, the active ray is preferably an ultraviolet ray. Ultraviolet curable resins are suitable for such purposes because they are easy to handle and available in different kinds.

In the present invention, it is preferred that a plane of the enclosed space forming device which forms the enclosed space facing the active ray irradiation device allows transmission of an active ray and the distance between the faced surface and an inner plane of the enclosed space forming device extending from the faced surface and the flexible support is 50 mm or less. Such construction makes it easier to control the oxygen concentration to the desired value and is suitable for reducing the amount of inert gas to be used.

In the present invention, it is preferred that a prechamber is disposed upstream of an inlet of the flexible support of the enclosed space forming device which forms the enclosed space and inert gas is introduced into the prechamber. The inert gas discharged from the prechamber having such a construction makes it easier to control the oxygen concentration to the desired value. Further, it is suitable for reducing the amount of the inert gas to be used.

In the present invention, it is preferred that a wind shielding board is disposed at a position 5 mm or less upstream of the inlet of the flexible support of the enclosed space forming device which forms the enclosed space in parallel with the inlet so as to be faced with the flexible support. When such a shielding board is installed, invasion of atmosphere (air) into the enclosed space can be prevented and it becomes easier to control the oxygen concentration to the desired value. Further, it is suitable for reducing the amount of the inert gas to be used. The above effect can be enhanced when a plurality of such wind shielding boards are disposed.

The present invention also provides a method of curing a coated film which includes irradiating an active ray by a plurality of active ray irradiation devices, wherein the coated film is composed of an active ray-curable resin formed on a surface of a running band-shaped flexible support, comprising the step of maintaining the coated film in a deoxidized atmosphere for 0.5 second or longer during a period in which the flexible support irradiated with an active ray by the at least one active ray irradiation device is transferred to the active ray irradiation device in a subsequent step.

According to the present invention, since the coated film is maintained in a deoxidized atmosphere for a predetermined time, the conditions for curing a coated film can be controlled to the optimal range, and the quality of the coated film, particularly, scratch resistance and adhesion, can be improved.

The present invention also provides an optical film comprising a coated layer formed by curing a coated film formed on a surface of the flexible support by the aforementioned method of curing a coated film.

According to the present invention, since the quality of a coated film (scratch resistance, adhesion, etc.) can be improved due to the aforementioned method of curing a coated film, high quality optical films can be obtained.

In the present invention, it is preferred that the coated layer comprises two or more layers and has an antireflection effect. A film having such a multilayer film structure is preferable as an optical film.

It is assumed that the above advantage is also found in the case of curing using electron beams.

As described above, according to the present invention, the coated film can be cured under a condition of variously controlled oxygen concentrations and the quality of the coated film, particularly, scratch resistance and adhesion, can be improved, and productivity can be greatly improved.

### BRIEF DESCRIPTION OF THE DRAWINGS

FIG. 1 is a block diagram of a production line for optical film which utilizes a curing method and apparatus of a coated film according to the present invention;

FIG. 2 is a cross-sectional view illustrating the configuration of a curing apparatus for the coated film of FIG. 1;

FIG. 3 is a cross-sectional view schematically illustrating the layered structure of a polarizing plate;

FIG. 4 is a cross-sectional view illustrating another configuration example of a curing apparatus for a coated film;

FIG. 5A is a cross-sectional view illustrating yet another configuration example of a curing apparatus for a coated film;

FIG. 5B is a cross-sectional view illustrating yet another configuration example of a curing apparatus for a coated film;

FIG. 6 is a cross-sectional view illustrating yet another configuration example of a curing apparatus for a coated film;

FIG. 7 is a cross-sectional view illustrating yet another configuration example of a curing apparatus for a coated film;

FIG. 8 is a cross-sectional view illustrating yet another configuration example of a curing apparatus for a coated film;

FIG. 9 is a cross-sectional view illustrating a configuration of a conventional coated film curing apparatus;

FIG. 10 is a table showing the results of Example 1;

FIG. 11 is a table showing the results of Example 2;

FIG. 12 is a table showing the results of Example 3; and

FIG. 13 is a table showing the results of Example 4.

### DETAILED DESCRIPTION OF THE PREFERRED EMBODIMENTS

In the following, a preferred embodiment (first aspect) of the method and the apparatus for curing a coated film and the optical film of the present invention is described in detail with reference to the attached figures.

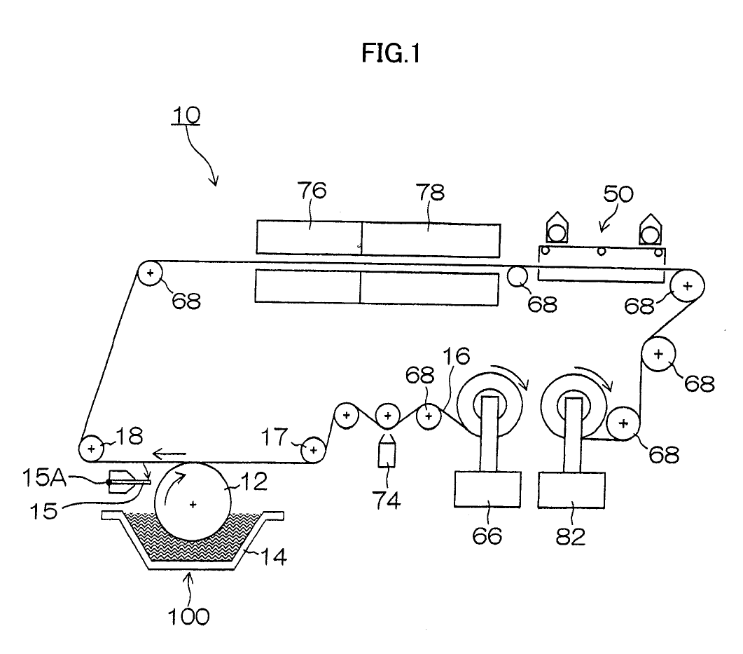

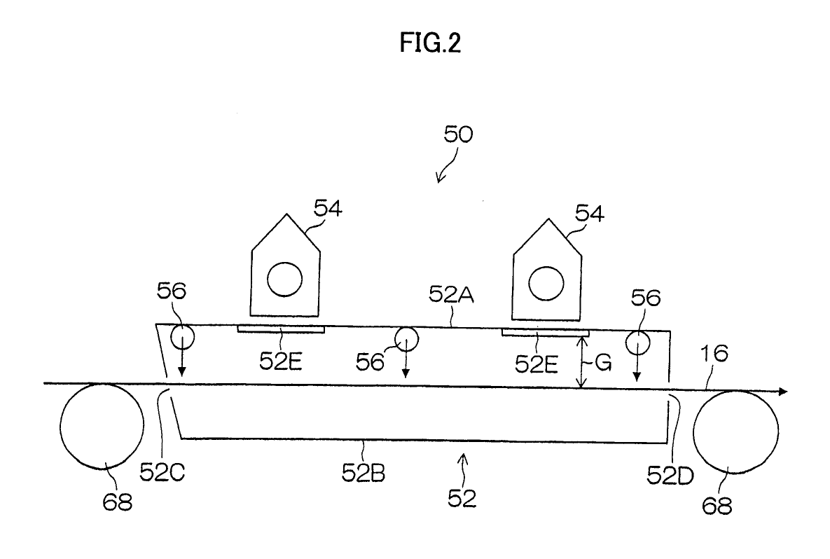

FIG. 1 is an explanatory view illustrating a production line for an optical film to which the method and the apparatus for curing a coated film of the present invention are adopted. FIG. 2 (cross-sectional view) illustrates an example of an apparatus for curing a coated film in the production line.

In the production line 10 for an optical film, a web 16 which is a transparent support on which a polymer layer is previously formed is fed from a feeder 66 as shown in FIG. 1. A guide roller 68 guides the web 16 to a duster 74 where dust adhered to the surface of the web 16 is removed.

A gravure coater 100 is installed in the downstream of the duster 74 so as to apply a coating solution to the web 16. The gravure coater 100 will be described in detail later.

A drying zone 76 and a heating zone 78 are provided in that order in the downstream of the gravure coater 100, where a liquid crystal layer is formed on the web 16. Further, a ultraviolet irradiation apparatus 50 which is an apparatus for curing a coated film having a plurality of active ray irradiation devices is provided in the downstream, and the liquid crystal is crosslinked by ultraviolet irradiation to form the desired polymer. The web 16 on which a polymer is formed is taken up by a winder 82 provided in the downstream of the ultraviolet irradiation apparatus.

Guide rollers 68, 68 . . . are provided all along the production line 10 for optical film, on which the web 16 is put to be held and transferred. The guide rollers 68 are rotational roller members having a length substantially the same as the width of the web 16 (slightly longer than the width of the web 16 in the first aspect).

The gravure coater 100 applies a coating solution to the web 16 traveling being guided by an upstream guide roller 17 and a downstream guide roller 18 by a rotationally driven gravure roller 12 in a predetermined thickness.

The length of the gravure roller 12, the upstream guide roller 17 and the downstream guide roller 18 is substantially the same as the width of the web 16. The gravure roller 12 is rotationally driven in the direction shown by the arrow in FIG. 1. The rotation direction is opposite to the traveling direction of the web 16. Application under forward rotation opposite from the rotation direction in FIG. 1 is also available depending on the coating condition.

The gravure roller 12 is directly driven by an inverter motor directly connected to the axis, or may be driven by various motors combined with a reduction gear (gear head) or by a wound communication device such as a timing belt leading from various motors.

The cell structure of the surface of the gravure roller 12 may be a known pyramidal, quadrangular or trihelical structure. An appropriate cell is selected depending on the application speed, the viscosity of the coating solution and the thickness of the coating layer.

A liquid receiving pan 14 is positioned under the gravure roller 12, which is filled with a coating solution. The bottom half of the gravure roller 12 is dipped in the coating solution. This construction supplies a coating solution to the cell on the surface of the gravure roller 12.

A doctor blade 15 is positioned at 10 o'clock relative to the gravure roller 12 in such a manner that the tip of the blade touches the roller to wipe off extra coating solution before coating. The doctor blade 15 is energized by an unrepresented energizing device in the direction of the arrow in FIG. 1 with the rotation center 15A at the end being the center.

The upstream guide roller 17 and the downstream guide roller 18 are held in parallel with the gravure roller 12. The both ends of the upstream guide roller 17 and the downstream guide roller 18 are rotatively held by a bearing member, e.g., a ball bearing, etc, to which no driving member may be attached.

The above-described gravure coater 100 is particularly useful for application of thin films, and is suitably applied to, for example, a production line for an optical film in which ultra thin layers are applied at a wet coating amount of 5 ml/m² or less (film thickness of 5 μm or less).

In the first aspect, the gravure coater 100 is to be placed in a clean atmosphere such as a clean room. In that case, the cleanliness class is preferably class 1000 or lower, more preferably class 100 or lower, and further preferably class 10 or lower.

In the present invention, the number of coated layer of the coating solution applied at one time is not limited to a single layer, and the present invention is also applicable to simultaneous multilayer application.

As a method of applying a coating solution, in addition to the above described gravure coater 100, a bar coater, a roll coater (transfer roll coater, reverse roll coater), a die coater, an extrusion coater, a fountain coater, a curtain coater, a dip coater, a spin coater, a spray coater or a slide hopper may be used.

In the production line for optically functional films shown in FIG. 1, the tension applied to the web 16 is preferably 100 to 500 N/m.

The ultraviolet irradiation apparatus 50 which is a characteristic of the present invention is now described. As shown in FIG. 2, the ultraviolet irradiation apparatus 50 comprises a tunnel-shaped housing 52 which is an enclosed space forming device which forms an enclosed space surrounding the web 16, two ultraviolet lamp houses 54, 54 which irradiate a coated film formed on the surface (upper surface) of the web 16 with ultraviolet light to cure the coated film and nozzles 56, 56 and 56 which introduce nitrogen gas (inert gas) into the enclosed space in the housing 52.

The housing 52 has an upper cover 52A and a lower cover 52B, and is thus shaped like a tunnel. Specifically, the web 16 is introduced through a slit 52C formed at the entrance (left side) of the housing 52 extending in the width direction (vertical to the sheet plane) of the web 16 and taken out from a slit 52D formed at the exit (right side) of the housing 52 extending in the width direction (vertical to the sheet plane) of the web 16.

In this housing 52, an enclosed space is formed not only between the ultraviolet lamp house 54 and the web 16, but also between the ultraviolet lamp houses 54, 54.

In the upper cover 52A of the housing 52, the portion facing the ultraviolet lamp house 54 is constituted by transparent boards 52E, 52E having a high ultraviolet ray transmittance, and the ultraviolet ray emitted from the ultraviolet lamp house 54 effectively reaches the coated film on the web 16. For the transparent board 52E, quartz glass is preferably employed.

Since the upper cover 52A has the transparent board 52E, and the upper cover 52A and the ultraviolet lamp house 54 are separately installed, influence from the ultraviolet lamp house 54 (e.g., heat distortion) on the upper cover 52A is small.

The distance G between the bottom face of the transparent board 52E and the coated film on the web 16 is preferably 50 mm or less. Such construction makes it easier to control the oxygen concentration to the desired value and is suitable for reducing the amount of inert gas to be used.

The nozzle 56 is a device which introduces nitrogen gas into the enclosed space inside the housing 52 and positioned so that nitrogen gas supplied from an unrepresented gas pipe is ejected in the direction of the arrow in the figure.

In the housing 52, an unrepresented probe of an oxygen analyzer is disposed. The above construction makes the inside of the housing 52 an enclosed space and the oxygen concentration can be controlled to the desired value by supplying inert gas such as nitrogen gas.

A structure of an antireflection film is now described as an example of an optical film of the present invention. The number of layers of an antireflection film may be selected depending on the purpose, but to be low reflective in a wide wavelength range, the film may have 3 or more layers. A three-layer antireflection film has a middle refractive index layer, a high refractive index layer and a low refractive index layer laminated in that order from the substrate side and known is a design in which each layer has an optical film thickness, i.e., a product of refractive index and film thickness is λ/4, λ/4, λ/4 or λ/4, λ/2, λ/4 relative to the design wavelength, as described in “Hanshaboshimaku no Tokusei to Saitekisekkei, Makusakusei Gijutu” (Antireflection Film and Optimal Design, Film Formation Technology)” (Technical Information Institute Co., Ltd., Feb. 5, 2002, p. 15 to 16).

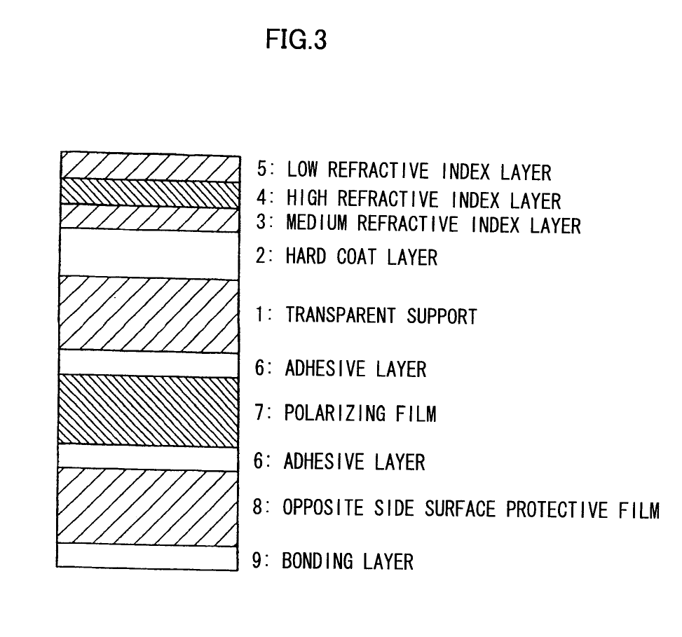

FIG. 3 is a cross-sectional view schematically illustrating a layer structure of a polarizing plate in which a multilayered antireflection film having excellent antireflection properties is formed on one side of a surface protection film. The antireflection film has a layer structure comprising a transparent support 1, a hard coat layer 2, a middle refractive index layer 3, a high refractive index layer 4 and a low refractive index layer (outermost layer) 5.

In the following, layers constituting an antireflection film are described in detail.

The transparent support is preferably a plastic film. Examples of plastic films include cellulose ester (e.g., triacetyl cellulose, diacetyl cellulose, propionyl cellulose, butyryl cellulose, acetyl propionyl cellulose, nitrocellulose) and polyolefin (e.g., polypropylene, polyethylene, polymethylpentene). Triacetyl cellulose and polyolefin are preferred for uses in a polarizing plate because of their small retardation and high optical uniformity, and in particular, when the film is used in a liquid crystal display device, triacetyl cellulose is preferred.

Triacetyl cellulose disclosed in Japanese Patent Application Laid-Open No. 2001-1745 is preferably used.

A hard coat layer is formed on the surface of the transparent support to give physical strength to the antireflection film.

It is preferred that the hard coat layer is formed by a cross-linking reaction or a polymerization reaction of an ionizing radiation curable compound. For example, the layer may be formed by applying a coating composition containing an ionizing radiation curable multifunctional monomer or multifunctional oligomer to a transparent support and subjecting the multifunctional monomer or multifunctional oligomer to a cross-linking reaction or a polymerization reaction. Further, the hard coat layer may contain inorganic fine particles in order to adjust the refractive index or the strength. The functional group of ionizing radiation curable multifunctional monomer or multifunctional oligomer may be photopolymerizable, electron beam polymerizable or radiation polymerizable, and in particular, photopolymerizable functional groups are preferred.

Examples of photopolymerizable functional group include unsaturated polymerizable functional groups such as a (meth)acryloyl group, a vinyl group, a styryl group and an allyl group, and of these, a (meth)acryloyl group is preferred.

Specific examples of photopolymerizable multifunctional monomers containing a photopolymerizable functional group include (meth)acrylic acid diesters of alkylene glycol such as neopentyl glycol acrylate, 1,6-hexanediol (meth)acrylate and propylene glycol di(meth)acrylate; (meth)acrylic acid diesters of polyoxyalkylene glycol such as triethylene glycol di(meth)acrylate, dipropylene glycol di(meth)acrylate, polyethylene glycol di(meth)acrylate and polypropylene glycol di(meth)acrylate; (meth)acrylic acid diesters of polyhydric alcohol such as pentaerythritol di(meth)acrylate; and (meth)acrylic acid diesters of ethylene oxide or propylene oxide adduct such as 2,2-bis{4-(acryloxydiethoxy)phenyl}propane and 2-2-bis{4-(acryloxypolypropoxy)phenyl}propane.

In addition, epoxy(meth)acrylates, urethane (meth)acrylates and polyester (meth)acrylates are preferably used as a photopolymerizable multifunctional monomer.

Of these, esters of polyhydric alcohol and (meth)acrylic acid are preferred. More preferred are multifunctional monomers containing 3 or more (meth)acryloyl groups in a molecule. Specific examples thereof include trimethylolpropane tri(meth)acrylate, trimethylolethane tri(meth)acrylate, 1,2,4-cyclohexane tetra(meth)acrylate, pentaglycerol triacrylate, pentaerythritol tetra(meth)acrylate, pentaerythritol tri(meth)acrylate, dipentaerythritol triacrylate, dipentaerythritol pentaacrylate, dipentaerythritol tetra(meth)acrylate, dipentaerythritol hexa(meth)acrylate, tripentaerythritol triacrylate and tripentaerythritol hexatriacrylate.

In the present specification, descriptions such as “(meth)acrylate” and “(meth)acryloyl” each mean “acrylate or methacrylate” and “acryloyl or methacryloyl”.

Two or more multifunctional monomers may be used together.

For a polymerization reaction of a photopolymerizable multifunctional monomer, a photoinitiator is preferably used. As a photopolymerization initiator, radical photopolymerization initiators and cationic photopolymerization initiators are preferred, and radical photopolymerization initiators are particularly preferred.

Examples of radical photopolymerization initiators include acetophenone, benzophenone, Michler's benzoyl benzoate, α-amyloxime ester, tetramethylthiuram monosulfide and thioxanthone.

Examples of commercially available radical photopolymerization initiators include KAYACURE (DETX-S, BP-100, BDMK, CTX, BMS, 2-EAQ, ABQ, CPTX, EPD, ITX, QTX, BTC, MCA, etc) available from NIPPON KAYAKU CO., LTD., IRGACURE (651, 184, 500, 907, 369, 1173, 2959, 4265, 4263, etc.) available from Nihon Ciba-Geigy K. K. and Esacure (KIP100F, KB1, EB3, BP, X33, KT046, KT37, KIP150, TZT) available from Sartomer Company Inc.

In particular, photocleavaging radical photopolymerization initiators are preferred. Such photocleavaging radical photopolymerization initiators are described in Saishin UV Koka Gijutsu (Latest UV Curing Technologies) (p. 159, published by Kazuhiro Kobo, Technical Information Institute Co., Ltd., 1991).

Examples of commercially available photocleavaging radical photopolymerization initiators include IRGACURE (651, 184, 907) available from Nihon Ciba-Geigy K. K.

The photoinitiator is used in an amount of preferably 0.1 to 15 parts by mass, more preferably 1 to 10 parts by mass based on 100 parts by mass of the multifunctional monomer.

In addition to the photoinitiator, a photosensitizer may be used. Specific examples of photosensitizers include n-butylamine, triethylamine, tri-n-butylphosphine, Michler's ketone and thioxanthone.

Examples of commercially available photosensitizers include KAYACURE (DMBI, EPA) available from NIPPON KAYAKU CO., LTD.

It is preferred that the photopolymerization reaction is performed by ultraviolet irradiation after applying a layer and drying.

An oligomer and/or a polymer having a weight average molecular weight of 500 or more may be added to the hard coat layer to impart brittleness to the layer.

Examples of oligomer and polymer include (meth)acrylate, cellulose or styrene polymers, urethane acrylate and polyester acrylate. Preferred are poly(glycidyl(meth) acrylate) having a functional group in a side chain and poly(allyl(meth)acrylate).

The content of the oligomer and/or polymer in the hard coat layer is preferably 5 to 80% by mass, more preferably 25 to 70% by mass, and particularly preferably 35 to 65% by mass based on the total mass of the hard coat layer.

Mat particles may be added to the hard coat layer so as to impart antiglare properties.

The hard coat layer has a strength of preferably H or higher, more preferably 2H or higher, and most preferably 3H or higher in the pencil hardness test in accordance with JIS K5400.

Further, in the Taber abrasion test in accordance with JIS K5400, the smaller the abrasion loss of a test piece before and after the test, the better.

When a hard coat layer is formed by a cross-linking reaction or a polymerization reaction of an ionizing radiation curable compound, the cross-linking reaction or the polymerization reaction is preferably performed in an atmosphere in which the oxygen concentration is 2% by volume or less. When formed in an atmosphere in which the oxygen concentration is 2% by volume or less, a hard coat layer excellent in physical strength and chemical resistance can be formed.

The hard coat layer is formed by a cross-linking reaction or a polymerization reaction of an ionizing radiation curable compound in an atmosphere in which the oxygen concentration is preferably 0.5% by volume or less, more preferably 0.1% by volume or less, and most preferably 0.05% by volume or less.

The oxygen concentration is brought to 2% by volume or less preferably by replacing air (nitrogen concentration about 79% by volume, oxygen concentration about 21% by volume) with another gas, particularly preferably with nitrogen (nitrogen purge).

The hard coat layer may be formed by applying a coating composition for forming a hard coat layer to the surface of a transparent support.

A ketone solvent is preferable as a coating solvent. When a ketone solvent is used, the adhesion between the transparent support (in particular, a triacetyl cellulose support) and the hard coat layer is further improved.

Particularly preferred coating solvents include methyl ethyl ketone, methyl isobutyl ketone and cyclohexanone.

The coating solvent may also contain a solvent other than a ketone solvent.

The content of the ketone solvent is 10% by mass or more, preferably 30% by mass or more, further preferably 60% by mass or more of the whole solvent contained in the coating composition.

In the present invention, the high refractive index layer of the antireflection film has a refractive index of preferably 1.60 to 2.40, more preferably 1.70 to 2.20. The refractive index of the middle refractive index layer is adjusted so that it is between the refractive index of the low refractive index layer and the refractive index of the high refractive index layer. The middle refractive index layer has a refractive index of preferably 1.55 to 1.80. The high refractive index layer and the middle refractive index layer have a haze of preferably 3% or less.

In the present invention, in the high refractive index layer and the middle refractive index layer, a cured product of a composition obtained by dispersing inorganic fine particles having a high refractive index in a mixture of a monomer, an initiator and a silicon compound substituted by an organic group is preferably used. Examples of inorganic fine particles include oxides of metals (e.g., aluminum, titanium, zirconium, antimony), and in view of the refractive index, fine particles of titanium dioxide are most preferred. When a monomer and an initiator are used, a middle refractive index layer or a high refractive index layer excellent in scratch resistance and adhesion can be formed by curing the monomer by a polymerization reaction using ionizing radiation or heat after application. The inorganic fine particles have an average particle size of preferably 10 to 100 nm.

The inorganic fine particles containing titanium oxide as a main component in the present invention have a refractive index of preferably 1.90 to 2.80, more preferably 2.10 to 2.80, most preferably 2.20 to 2.80.

Primary particles of the inorganic fine particles containing titanium oxide as a main component have a weight average particle size of preferably 1 to 200 nm, more preferably 1 to 150 nm, further preferably 1 to 100 nm, and particularly preferably 1 to 80 nm.

The particle size of inorganic fine particles can be measured by a light scattering method or in an electron micrograph. The inorganic fine particles have a specific surface area of preferably 10 to 400 m²/g, more preferably 20 to 200 m²/g, further preferably 30 to 150 m²/g.

Referring to the crystal structure of the inorganic fine particles containing titanium oxide as a main component, the main structure may be a rutile structure, a mixed crystal of rutile/anatase, an anatase structure or an amorphous structure, and most preferably a rutile structure.

When inorganic fine particles containing titanium oxide as a main component contains at least one element selected from Co (cobalt), Al (aluminum) and Zr (zirconium), photocatalytic activity of titanium dioxide can be suppressed and the weatherability of the high refractive index layer and the middle refractive index layer in the present invention can be improved.

A particularly preferred element is Co (cobalt). It is also preferable to use two or more elements.

In the present invention, a dispersant may be used for dispersing inorganic fine particles containing titanium dioxide as a main component used for a high refractive index layer and a middle refractive index layer.

In the present invention, a dispersant containing an anionic group is particularly preferably used for dispersing inorganic fine particles containing titanium dioxide as a main component.

As an anionic group, a group containing an acidic proton such as a carboxyl group, a sulfonic acid group (and a sulfo group), a phosphate group (and a phosphono group), a sulfonamide group and a salt thereof are preferred. In particular, a carboxyl group, a sulfonic acid group, a phosphate group and a salt thereof are preferred, and a carboxyl group and a phosphate group are particularly preferred. The dispersant may contain one or more anionic groups per molecule.

To further improve the dispersibility of inorganic fine particles, a plurality of anionic groups may be contained. The dispersant may contain an average of preferably 2 or more anionic groups, more preferably 5 or more anionic groups, particularly preferably 10 or more anionic groups. The dispersant may contain plural kinds of anionic groups in a molecule.

It is preferable that the dispersant further contains a cross-linkable or a polymerizable functional group. Examples of cross-linkable or polymerizable functional groups include ethylenically unsaturated groups capable of inducing an addition reaction or a polymerization reaction with radical species (e.g., a (meth)acryloyl group, an allyl group, a styryl group, a vinyloxy group), cationically polymerizable groups (an epoxy group, a oxetanyl group, vinyloxy group) and polycondensation reactive groups (a hydrolyzable silyl group, N-methylol), and preferred are functional groups having an ethylenically unsaturated group.

In the present invention, a preferred dispersant for dispersing inorganic fine particles containing titanium dioxide used for a high refractive index layer is a dispersant containing an anionic group and a cross-linkable or a polymerizable functional group and containing the cross-linkable or polymerizable functional group in its side chain.

The dispersant containing an anionic group and a cross-linkable or a polymerizable functional group in its side chain may have a weight average molecular weight (Mw) of 1000 or more, more preferably 2000 to 1000000, further preferably 5000 to 200000, and particularly preferably 10000 to 100000.

The dispersant is used in an amount of 1 to 50% by mass, more preferably 5 to 30% by mass, and most preferably 5 to 20% by mass based on the amount of inorganic fine particles. Further, two or more dispersants may be used together.

The inorganic fine particles containing titanium dioxide as a main component used for a high refractive index layer and a middle refractive index layer are used for forming a high refractive index layer and a middle refractive index layer in the form of dispersion.

The inorganic fine particles are dispersed in a dispersion medium in the presence of the aforementioned dispersant.

As a dispersion medium, liquid whose boiling point is 60 to 170° C. is preferably used. Examples of dispersion media include water, alcohol (e.g., methanol, ethanol, isopropanol, butanol, benzyl alcohol), ketone (e.g., acetone, methyl ethyl ketone, methyl isobutyl ketone, cyclohexanone), ester (e.g., methyl acetate, ethyl acetate, propyl acetate, butyl acetate, methyl formate, ethyl formate, propyl formate, butyl formate), aliphatic hydrocarbon (e.g., hexane, cyclohexane), halogenated hydrocarbon (e.g., methylene chloride, chloroform, carbon tetrachloride), aromatic hydrocarbon (e.g., benzene, toluene, xylene), amide (e.g., diemthylformamide, dimethylacetamide, n-methylpyrrolidone), ether (e.g., diethylether, dioxane, tetrahydrofuran) and ether alcohol (e.g., 1-methoxy-2-propanol). Preferred are toluene, xylene, methyl ethyl ketone, methyl isobutyl ketone, cyclohexanone and butanol.

Particularly preferred dispersion media are methyl ethyl ketone, methyl isobutyl ketone and cyclohexanone.

The inorganic fine particles are dispersed using a dispersing machine. Examples of dispersing machines include sand grinder mill (e.g., beads mill with pins), a high-speed impeller mill, a pebble mill, a roller mill, an attritor and a colloid mill. A sand grinder mill and a high-speed impeller mill are particularly preferred. The inorganic fine particles may be subjected to pre-dispersing. Dispersing machines used for pre-dispersing include a ball mill, a three-roll mill, a kneader and an extruder.

It is preferred that the inorganic fine particles are dispersed as finely as possible in the dispersion medium, and the inorganic fine particles have a weight average particle size of 1 to 200 nm, preferably 5 to 150 nm, more preferably 10 to 100 nm, and particularly preferably 10 to 80 nm.

By making inorganic fine particles as small as 200 nm or less, a high refractive index layer and a middle refractive index layer maintaining transparency can be formed.

The high refractive index layer and the middle refractive index layer used in the present invention may be formed by preparing a coating composition for forming a high refractive index layer and a middle refractive index layer preferably by adding a binder precursor necessary for forming matrix (for example, an ionizing radiation curable multifunctional monomer or multifunctional oligomer described in the case of the hard coat layer) or a photoinitiator to the dispersion obtained by dispersing inorganic fine particles in a dispersion medium as described above, and applying the coating composition for forming a high refractive index layer and a middle refractive index layer to a transparent support, and curing by a cross-linking reaction or a polymerization reaction of the ionizing radiation curable compound.

Further, the binder in the high refractive index layer and the middle refractive index layer is preferably cross-linked or polymerized with the dispersant at the time of or after application.

Referring to the binder in the high refractive index layer and the middle refractive index layer prepared as above, for example, the above-described preferred dispersant and the ionizing radiation curable multifunctional monomer or the multifunctional oligomer are cross-linked or polymerized, and the anionic group in the dispersant is incorporated into the binder. Further, because anionic groups have a function to maintain the dispersion state of the inorganic fine particles and the binder has coating forming ability due to the cross-linked or polymerized structure, the binder in the high refractive index layer and the middle refractive index layer improves the physical strength, the chemical resistance and the weatherability of the high refractive index layer and the middle refractive index layer containing inorganic fine particles.

In addition to the aforementioned components (inorganic fine particles, polymerization initiator, photosensitizer), a resin, a surfactant, an antistatic agent, a coupling agent, a thickener, a color protection agent, a coloring agent (pigment, dye), a defoaming agent, a leveling agent, a flame retardant, an ultraviolet absorber, an infrared absorber, a tackifier, a polymerization inhibitor, an antioxidant, a surface modifier and conductive metal fine particles may be added to the high refractive index layer and the middle refractive index layer.

Since the high refractive index layer is located immediately below the low refractive index layer, it is necessary to adjust surface roughness and curing conditions to give adhesion between the low refractive index layer and the high refractive index layer.

The surface roughness (Ra) can be measured using an atomic force microscope. To improve the interlayer bonding, the surface roughness is preferably 1 nm or higher, more preferably 2 nm or higher, and most preferably 3 nm or higher. On the other hand, a surface roughness of 20 nm or higher is not preferred because the haze of the film may increase and there may be a significant refractive index gradient between the low refractive index layer and the high refractive index layer. The surface roughness varies depending on the amount and the particle size of the inorganic fine particles added to the high refractive index layer and the film thickness of the high refractive index layer, and so it is necessary to control these factors.

To improve the adhesion to the low refractive index layer, the high refractive index layer should have unreacted bonding groups on the surface upon application of the low refractive index layer. For this reason, the high refractive index layer is preferably half-cured.

The amount of residual double bonds is dependent on the oxygen concentration upon curing, irradiance, dose and the kind and the amount of the initiator.

The lower the degree of curing, the higher the amount of residual double bonds, but too low a degree of curing is not preferable because interface mixing occurs between the low refractive index layer and the high refractive index layer upon formation of the low refractive index layer, and optical properties cannot be controlled or the surface profile is deteriorated.

The amount of double bonds remaining on the surface can be quantified by measuring the peak strength with ESCA after modifying unsaturated bonds by bromine. The amount of double bonds remaining on the lower layer surface can be represented by the ratio of the surface double bond amount A before curing to the residual surface double bond amount B after curing. The closer to 0 the B/A, the more completely the layer is cured. From this, the residual ratio B/A is preferably 0.2 to 0.9, more preferably 0.3 to 0.8.

It is preferred that the low refractive index layer is composed of a cured coated film of a copolymer containing a repeat unit derived from a fluorine containing vinyl monomer and a repeat unit having a (meth)acryloyl group in a side chain as essential components. The component derived from the copolymer accounts for preferably 20% by mass or more, more preferably 40% by mass or more, and particularly preferably 80% by mass or more of the coating resin. A curing agent such as multifunctional (meth)acrylate is preferably used in such an amount that the compatibility is not affected in order to achieve both low refractive index and hardness of the coated film.

The low refractive index layer has a refractive index of preferably 1.20 to 1.50, more preferably 1.25 to 1.48, and particularly preferably 1.30 to 1.46.

The low refractive index layer has a thickness of preferably 50 to 200 nm, more preferably 70 to 130 nm, and a haze of preferably 3% or lower, more preferably 2% or lower, and most preferably 1% or lower. The low refractive index layer has a strength of preferably H or higher, more preferably 2H or higher, and most preferably 3H or higher in a pencil hardness test at a load of 500 g.

To improve the antifouling property of the antireflection film, it is preferred that the contact angle of the surface with water is 90° or more, more preferably 95° or more, and particularly preferably 100° or more.

The copolymer used for the low refractive index layer is described below.

Examples of fluorine containing vinyl monomers include fluoroolefins (e.g., fluoroethylene, vinylidene fluoride, tetrafluoroethylene, hexafluoropropylene), partially fluorinated or fluorinated alkyl ester derivatives of (meth)acrylic acid (e.g., Viscoat 6FM (product name, available from OSAKA ORGANIC CHEMICAL INDUSTRY LTD.) and M-2020 (product name, available from DAIKIN INDUSTRIES, LTD.) and fluorinated or partially fluorinated vinyl ethers. Preferred are perfluoroolefins, and particularly preferred is hexafluoropropylene in view of the refractive index, solubility, transparency and availability. Although the refractive index can be lowered when the composition ratio of the fluorine containing vinyl monomer is increased, the film strength is decreased. In the present invention, the fluorine containing monomer is introduced so that the fluorine content of the copolymer is preferably 20 to 60% by mass, more preferably 25 to 55% by mass, particularly preferably 30 to 50% by mass.

The copolymer may contain a repeat unit having a (meth)acryloyl group in a side chain as an essential component. The film strength increases when the composition ratio of the (meth)acryloyl group containing repeat unit, the refractive index also increases. Generally, the (meth)acryloyl group containing repeat unit accounts for preferably 5 to 90% by mass, more preferably 30 to 70% by mass, particularly preferably 40 to 60% by mass of the copolymer, although the ratio may be different depending on the kind of the repeat unit derived from a fluorine containing monomer.

In a useful copolymer, in addition to the above-described repeat unit derived from a fluorine containing vinyl monomer and repeat unit containing a (meth)acryloyl group in a side chain, another vinyl monomer may be accordingly copolymerized in view of adhesion to substrates, Tg of the polymer (contributing to film hardness), solubility in the solvent, transparency, lubricity and antidust and antifouling properties. A plurality of these vinyl monomers may be combined depending on the purpose, and they are introduced into the copolymer in a proportion of preferably 0 to 65% by mole, more preferably 0 to 40% by mole, 0 to 30% by mole of the copolymer in total.

The vinyl monomer unit that can be used in combination is not particularly limited and examples thereof include olefins (ethylene, propylene, isoprene, vinyl chloride, vinylidene chloride), acrylic esters (methyl acrylate, ethyl acrylate, 2-ethylhexyl acrylate, 2-hydroxyethyl acrylate), methacrylic esters (methyl methacrylate, ethyl methacrylate, butyl methacrylate, 2-hydroxyethyl methacrylate), styrene derivatives (styrene, p-hydroxymethylstyrene, p-methoxystyrene), vinyl ethers (methyl vinyl ether, ethyl vinyl ether, cyclohexyl vinyl ether, hydroxyethyl vinyl ether, hydroxybutyl vinyl ether), vinyl esters (vinyl acetate, vinyl propionate, vinyl cinnamate), unsaturated carboxylic acids (acrylic acid, methacrylic acid, crotonic acid, maleic acid, itaconic acid), acrylamides (N,N-dimethylacrylamide, N-tert-butylacrylamide, N-cyclohexylacrylamide), methacrylamides (N,N-dimethylmethacrylamide) and acrylonitrile.

Preferred configurations of the copolymer used in the present invention include those represented by the following formula 1:

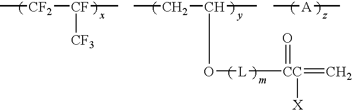

wherein L is a linking group having 1 to 10 carbon atoms, more preferably a linking group having 1 to 6 carbon atoms, particularly preferably a linking group having 2 to 4 carbon atoms, which may be linear, may have a branched structure or a cyclic structure, and may contain a hetero atom selected from O, N and S.

Preferred examples thereof include *—(CH₂)₂—O—**, *—(CH₂)₂—NH—**, *—(CH₂)₄—O—**, *—(CH₂)₆—O—**,*—(CH₂)₂—O—(CH₂)₂—O—**, —CONH—(CH₂)₃—O—**, *—CH₂CH(OH)CH₂—O—* and *—CH₂CH₂OCONH(CH₂)₃—O—** (* represents a linking moiety on the polymer main chain side and ** represents a linking moiety on the (meth)acryloyl group side). m represents 0 or 1.

In the formula 1, X represents a hydrogen atom or a methyl group. In view of curing reactivity, X is preferably a hydrogen atom.

In the formula 1, A represents a repeat unit derived from any vinyl monomer, and is not particularly limited as long as it is a monomer component copolymerizable with hexafluoropropylene. The monomer component may be accordingly selected in view of adhesion to substrates, Tg of the polymer (contributing to film hardness), solubility in the solvent, transparency, lubricity and antidust and antifouling properties. The monomer component may be composed of a single vinyl monomer or plural kinds of vinyl monomers.

Preferred examples thereof include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether and allyl vinyl ether, vinyl esters such as vinyl acetate, vinyl propionate and vinyl butyrate, (meth)acrylates such as methyl(meth)acrylate, ethyl(meth)acrylate, hydroxyethyl (meth)acrylate, glycidyl methacrylate, allyl(meth)acrylate and (meth)acryloyloxypropyltrimethoxysilane, styrene, styrene derivatives such as p-hydroxymethyl styrene and unsaturated carboxylic acid such as crotonic acid, maleic acid and itaconic acid and derivatives thereof. More preferred are vinyl ether derivatives and vinyl ester derivatives, and particularly preferred are vinyl ether derivatives.

x, y and z represent % by mole of each constituent, which satisfy 30=x=60, 5=y=70 and 0=z=65, preferably 35=x=55, 30=y=60 and 0=z=20, and particularly preferably 40=x=55, 40=y=55 and 0=z=10.

Particularly preferred configurations of the copolymer used in the present invention include those represented by the following formula 2.

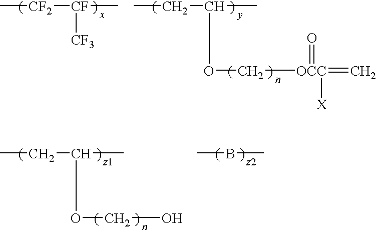

In the formula 2, X, x and y have the same meaning as defined in the formula 1, and their preferred range is also the same.

n is an integer of 2=n=10, preferably 2=n=6, particularly preferably 2=n=4.

B represents a repeat unit derived from any vinyl monomer, and may have a single composition or a composition of plural monomers. Examples thereof are those described as examples of A in the aforementioned formula 1.

z1 and z2 represent % by mole of each repeat unit, which satisfy 0=z1=65, 0=z2=65. They are preferably 0=z1=30, 0=z2=10, and particularly preferably 0=z1=10, 0=z2=5.

The copolymer represented by the formulas 1 and 2 can be synthesized by, for example, introducing a (meth)acryloyl group to a copolymer containing a hexafluoropropylene component and a hydroxyalkyl vinyl ether component by any one of the aforementioned method.

The composition for forming a low refractive index layer used in the present invention is usually in the form of liquid and is produced by dissolving the aforementioned copolymer as an essential component and various additives and radical polymerization initiators according to need in an appropriate solvent. The concentration of the solid component in that case is appropriately selected depending on the purpose, and is usually about 0.01 to 60% by mass, preferably about 0.5 to 50% by mass, particularly preferably about 1% to 20% by mass.

As described above, in view of the film hardness of the low refractive index layer, addition of an additive such as a curing agent is not always advantageous, but in view of the interfacial adhesion with the high refractive index layer, a small amount of a curing agent such as a multifunctional (meth)acrylate compound, a multifunctional epoxy compound, a polyisocyanate compound, aminoplast, polybasic acid or anhydride thereof, or inorganic fine particles such as silica may be added. These components may be added in an amount of preferably 0 to 30% by mass, more preferably 0 to 20% by mass, and particularly preferably 0 to 10% by mass based on the total solid contents of the coating of the low refractive index layer.

In addition, to impart antifouling properties, water resistance, chemical resistance and lubricity to the layer, a known silicone or fluorine antifouling agent or a lubricant may also be accordingly added. These additives are added in an amount of preferably 0 to 20% by mass, more preferably 0 to 10% by mass, and particularly preferably 0 to 5% by mass based on the total solid contents of the low refractive index layer.

As a radical polymerization initiator, either an initiator generating radicals by the action of heat or an initiator generating radicals by the action of light may be used.

As a compound which initiates radical polymerization by the action of heat, organic or inorganic peroxides and organic azo or diazo compounds may be used.

Specifically, examples thereof include organic peroxides such as benzoyl peroxide, halogenated benzoyl peroxide, lauroyl peroxide, acetyl peroxide, dibutyl peroxide, cumene hydroperoxide and butyl hydroperoxide, inorganic peroxides such as hydrogen peroxide, ammonium persulfate and potassium persulfate, azo compounds such as 2-azo-bis-isobutylonitrile, 2-azo-bis-propionitrile, 2-azo-bis-cyclohexanedinitrile, and diazo compounds such as diazoaminobenzene and p-nitrobenzene diazonium.

In the case of using a compound which initiates radical polymerization by the action of light, the coated film is cured by irradiation of active energy rays.

Examples of such radical photopolymerization initiators include acetophenones, benzoins, benzophenones, phosphine oxides, ketals, anthraquinones, thioxanthones, azo compounds, peroxides, 2,3-dialkyldione compounds, disulfide compounds, fluoroamine compounds and aromatic sulfonium compounds. Examples of acetophenones include 2,2-diethoxyacetophenone, p-dimethylacetophenone, 1-hydroxydimethylphenylketone, 1-hydroxycyclohexylphenylketone, 2-methyl-4-methylthio-2-morpholinopropiophenone and 2-benzyl-2-dimethylamino-1-(4-morpholinophenyl)butanone. Examples of benzoins include benzoin benzenesulfonic acid ester, benzoin toluenesulfonic acid ester, benzoin methyl ether, benzoin ethyl ether and benzoin isopropyl ether. Examples of benzophenones include benzophenone, 2,4-dichlorobenzophenone, 4,4-dichlorobenzophenone and p-chlorobenzophenone. Examples of phosphine oxides include 2,4,6-trimethylbenzoyldiphenylphosphine oxide. A sensitizing dye may also be used in combination with these radical photopolymerization initiators.

The compound which initiates radical polymerization by the action of heat or light is added in such an amount that polymerization of carbon-carbon double bond can be started, and the amount is generally preferably 0.1 to 15% by mass, more preferably 0.5 to 10% by mass and particularly preferably 2 to 5% by mass based on the total solid contents in the composition for forming a low refractive index layer.

The solvent contained in the low refractive index layer coating solution composition is not particularly limited as long as a composition containing a fluorine containing copolymer can be uniformly dissolved or dispersed therein without causing precipitation, and two or more solvents may be used in combination. Preferred examples thereof include ketones (acetone, methyl ethyl ketone, methyl isobutyl ketone, etc.), esters (ethyl acetate, butyl acetate, etc.), ethers (tetrahydrofuran, 1,4-dioxane, etc.), alcohols (methanol, ethanol, isopropyl alcohol, butanol, ethylene glycol, etc.), aromatic hydrocarbons (toluene, xylenes) and water.

The low refractive index layer may contain, in addition to a fluorine containing compound, a filler (e.g., inorganic fine particles or organic fine particles), a silane coupling agent, a lubricant (silicone compounds such as dimethyl silicone) and/or a surfactant. In particular, the low refractive index layer may contain inorganic fine particles, a silane coupling agent and/or a lubricant.

Examples of inorganic fine particles include silicon dioxide (silica) and fluorine containing particles (magnesium fluoride, calcium fluoride and barium fluoride). Silicon dioxide (silica) is particularly preferred. The primary particles of the inorganic fine particles have a weight average particle size of preferably 1 to 150 nm, more preferably 1 to 100 nm, and most preferably 1 to 80 nm. It is preferred that inorganic fine particles are more finely dispersed in the outermost layer. The inorganic fine particles may be rice grain-shaped, spherical, cubic, spindle-shaped, short fiber-shaped, ring-shaped or amorphous. In order to lower the refractive index, the inorganic fine particle is preferably hollow silica.

The hollow silica fine particles have a refractive index of preferably 1.17 to 1.40, more preferably 1.17 to 1.35, and most preferably 1.17 to 1.30. The refractive index mentioned herein represents the refractive index of the particles as a whole, not the refractive index of silica in the outer layer constituting the hollow silica particles. In that case, when the radius of the cavity of the particle is represented as “a” and the radius of the outer shell of the particle is represented by “b”, the porosity “x” is represented by the following formula (VIII):

x=(4pa³/3)/(4pb³/3)×100=(a/b)³×100 (Formula VIII)

is preferably 10 to 60%, more preferably 20 to 60%, most preferably 30 to 60%. When it is attempted to further lower the refractive index and to increase the porosity of the hollow silica particles, the outer shell becomes thin and the strength of particles is decreased. Thus, in view of scratch resistance, particles having a low refractive index of 1.17 or less are impractical.

The method of producing hollow silica is described, for example, in Japanese Patent Application Laid-Open No. 2001-233611 and Japanese Patent Application Laid-Open No. 2002-79616.

As a silane coupling agent, compounds represented by the following formula A and/or derivative compounds thereof may be used. Preferred are silane coupling agents containing a hydroxyl group, a mercapto group, a carboxyl group, an epoxy group, an alkyl group, an alkoxysilyl group, an acyloxy group or an acylamino group.

Particularly preferred are silane coupling agents containing an epoxy group, a polymerizable acyloxy((meth)acryloyl) group or a polymerizable acylamino(acrylamino, methacrylamino) group.

(R10)ₘ-Si(X)4-ₘ Formula A

(wherein R10 represents a substituted or unsubstituted alkyl group or a substituted or unsubstituted aryl group, X represents a hydroxyl group or a hydrolyzable group, and m represents an integer of 1 to 3)

Particularly preferred examples of compounds represented by the formula A include compounds containing a (meth)acryloyl group as a cross-linkable or a polymerizable functional group, e.g., 3-acryloxypropyl trimethoxysilane and 3-methacryloxypropyl trimethoxysilane.

As a lubricant, dimethyl silicone and fluorine compounds into which a polysiloxane segment is introduced are preferred.

It is preferred that the low refractive index layer is formed by a cross-linking reaction or a polymerization reaction by light irradiation, electron beam irradiation or heating, simultaneously with or after applying a coating composition in which a fluorine containing compound and an optional component added as desired are dissolved or dispersed.

In particular, to improve adhesion to a high refractive index layer, it is necessary to firmly bond the low refractive index layer to the high refractive index layer. Thus, the oxygen concentration upon curing the low refractive index layer is preferably 0.3% or lower, more preferably 0.1% or lower, and most preferably 0.05% or lower. Further, the dose is preferably 250 mJ/cm² or higher, more preferably 500 mJ/cm² or higher, and most preferably 750 mJ/cm² or higher.

As described above, to manufacture an antireflection film having superior antireflection properties, a middle refractive index layer having a refractive index between the refractive index of the high refractive index layer and the refractive index of the transparent support is preferably formed.

It is preferred that the middle refractive index layer is produced in the same manner as described in the case of the high refractive index layer in the present invention, and the refractive index can be adjusted by controlling the content of inorganic fine particles in the coating.

The antireflection film may also have a layer other than the above-described layers. For example, the film may have an adhesive layer, a shield layer, a sliding layer or an antistatic layer. The shield layer is formed so as to block electromagnetic waves or infrared rays.

When the antireflection film is applied to a liquid crystal display device, an undercoat layer to which particles having an average particle size of 0.1 to 10 μm are added may be additionally formed or such particles may be added to the hard coat layer to form a light scattering hard coat layer in order to improve viewing angle characteristics. The particles may have an average particle size of preferably 0.2 to 5.0 μm, more preferably 0.3 to 4.0 μm, and particularly preferably 0.5 to 3.5 μm.

The particles have a refractive index of preferably 1.35 to 1.80, more preferably 1.40 to 1.75, more preferably 1.45 to 1.75. The narrower the particle size distribution, the better.

The difference between the refractive index of particles and the refractive index of an undercoat layer or a light scattering hard coat layer in a portion other than the particles (mainly a binder component composed of resin such as multifunctional monomer, which may contain inorganic fine particles for controlling refractive index) is preferably 0.02 or greater, more preferably 0.03 to 0.5, further preferably 0.05 to 0.4, particularly preferably 0.07 to 0.3.

As particles to be added to the undercoat layer, various inorganic or organic particles satisfying the above refractive index may be used.

The undercoat layer may be formed between the hard coat layer and the transparent support. The undercoat layer may also serve as a hard coat layer.

When particles having an average particle size of 0.1 to 10 μm are added to the undercoat layer, the undercoat layer has a haze of preferably 3 to 60%, more preferably 5 to 50%, further preferably 7 to 45%, and particularly preferably 10 to 40%.

The layers of the antireflection film may be formed by an application method such as wire-bar coating, reverse gravure coating, direct gravure coating and die coating as described above. In view of reducing unevenness in drying by minimizing the wet coating amount, uniform film thickness in the width direction and uniform film thickness in the longitudinal direction after coating, reverse gravure coating and die coating are particularly preferred.

It is preferred that at least two layers of optical thin films of the antireflection film of the present invention are formed in a single step of feeding of support film, formation of optical thin films and winding of films in view of the production cost.

When the antireflection layer has a three-layer structure, it is more preferred that the three layers are formed in one step. Such production method can be achieved by installing plural sets, preferably as many as the number of optical thin films, of an application station and a drying and curing zone in sequence between feeding of support film and winding in a coater.

The production line 10 for optical film shown in the above FIG. 1 illustrates a simplified structure of the above production process.

When producing a polarizing plate of the present invention, in order to use the antireflection film as a surface protection film of a polarizing film (film for protecting a polarizing plate), it is essential to improve adhesion between a transparent support and a polarizing film containing polyvinyl alcohol as a main component by hydrophilizing the surface of the transparent support opposite from the side where a high refractive index layer is formed, i.e., the surface bonded to the polarizing film.

As a transparent support, triacetyl cellulose film is particularly preferably used.

Methods of preparing a film for protecting a polarizing plate include (1) a method of applying the above-described layers (e.g., high refractive index layer, hard coat layer, outermost layer, etc.) to one surface of a transparent support previously saponified and (2) a method comprising applying the above-described layers (e.g., high refractive index layer, hard coat layer, low refractive index layer, outermost layer, etc.) to one surface of a transparent support and then saponifying the surface which is to be bonded to a polarizing film. In (1), since the surface on which a hard coat layer is formed is also saponified, it is difficult to maintain adhesion between the support and the hard coat layer, and thus the method in (2) is preferred.

In the following, saponification is described.

### (1) Dipping

This method involves dipping an antireflection film in an alkali solution under appropriate conditions to saponify the entire surface of the film reactive with alkali. As this method requires no special equipment, it is preferred in view of the cost. The alkali solution is preferably a sodium hydroxide solution. The concentration of the alkali solution is preferably 0.5 to 3 mol/l, particularly preferably 1 to 2 mol/l. The temperature of the alkali solution is preferably 30 to 70° C., particularly preferably 40 to 60° C.

Referring to the combination of the above-described saponification conditions, a combination of relatively mild conditions is preferred, and they may be determined based on the material and the structure of the antireflection film and the intended contact angle.

After dipping in an alkali solution, the film may be thoroughly washed with water or dipped in dilute acid to neutralize the alkali component so that the alkali component does not remain in the film.

Saponification makes the surface of a transparent support opposite from the surface having an antireflection layer hydrophilic. The film for protecting a polarizing plate is used as a protection film as the hydrophilized surface of the transparent support is bonded to the polarizing film.

The hydrophilized surface is effective for improving adhesion to an adhesive layer containing polyvinyl alcohol as a main component.

Saponification is preferred when the surface of the transparent support opposite from the surface having a high refractive index layer has a small contact angle with water in view of the adhesion to the polarizing film. In dipping, however, since the surface having a high refractive index layer is also affected by alkali, it is important that the reaction conditions are the minimum necessary. When the contact angle against water of the surface of the transparent support opposite from the surface having an antireflection structure layer, i.e., the bonding surface of the antireflection film, is employed as an index of damage on an antireflection layer caused by alkali, the contact angle is 20 degrees to 50 degrees, preferably 30 degrees to 50 degrees, more preferably 40 degrees to 50 degrees when the support is composed of triacetyl cellulose. A contact angle of larger than 50 degrees is not preferred because there is a problem of adhesion to the polarizing film. On the other hand, a contact angle of smaller than 20 degrees is not preferred because damage on the antireflection film is too high, resulting in loss of physical strength and light resistance.

### (2) Alkali Solution Application

As a technique for eliminating damage on an antireflection film in the above-described dipping method, alkali solution application comprising applying an alkali solution only to the surface having an antireflection film and the opposite surface under appropriate conditions, heating, washing with water and drying is preferably employed. Application in this case represents to bring an alkali solution into contact only with the surface to be saponified, and it is preferable that the surface is saponified so that the bonding surface of the antireflection film has a contact angle with water of 10 to 50 degrees. Further, in addition to application, spraying or contacting with a belt impregnated with the solution is also available. When such a method is adopted, separate equipment and steps for applying an alkali solution are required, and so the method is disadvantageous compared to dipping described in (1) in view of the cost. On the other hand, however, since the alkali solution comes into contact only with the surface to be saponified, a layer composed of a material vulnerable to alkali solution may be formed on the opposite surface. For example, since evaporated films and sol-gel films suffer from various problems such as corrosion, dissolution and peeling caused by alkali solution, these films should not be formed when dipping is employed, but they can be used without problems in the alkali solution application method.

Both the above saponification methods (1) and (2) can be performed after feeding out rolled support and forming layers, and so saponification may be performed in a series of operations following the aforementioned step for producing an antireflection film. Further, by continuously performing the step of bonding to a polarizing plate composed of rolled out support, a polarizing plate can be efficiently produced compared to performing the same operation in the sheet form.

A preferred polarizing plate has the antireflection film of the present invention on at least one side of the protection film of a polarizing film (film for protecting a polarizing plate) as shown in FIG. 3. Referring to FIG. 3, a transparent support (1) of an antireflection film is adhered to a polarizing film (7) via an adhesive layer (6) containing polyvinyl alcohol, and another protection film of the polarizing film (8) is bonded to the principal plane of the polarizing film (7) opposite from the principal plane to which the antireflection film is bonded via an adhesive layer (6). A tackifier layer (9) is formed on the principal plane of the other protection film (8) opposite from the principal plane bonded to the polarizing film.

By using the antireflection film of the present invention as a film for protecting a polarizing plate, a polarizing plate having excellent physical strength and light resistance can be prepared and significant cost reduction and thinning of display devices can be achieved.

Further, when a polarizing plate is produced using the antireflection film of the present invention as a protection film of the polarizing plate and an optical compensation film having optical anisotropy described later as another protection film of the polarizing film, a polarizing plate which can improve the contrast of liquid crystal display device under daylight and can greatly broaden the viewing angle in the vertical and horizontal directions can be obtained.

An optical compensation film (retardation film) improves viewing angle characteristics of a liquid crystal display screen.

As an optical compensation film, a known film can be used. For increasing the viewing angle, preferred is an optical compensation film described in Japanese Patent Application Laid-Open No. 2001-100042, which has an optically anisotropic layer composed of a compound having a discotic structure unit and in which the angle formed by the discotic compound and the support varies according to the distance from the transparent support.

It is preferred that the angle increases along with the increase in the distance from the support in the optically anisotropic layer.

When an optical compensation film is used as a protection film of a polarizing film, the surface bonded to the polarizing film is preferably saponified by the aforementioned saponification method.

In addition, also preferred are an embodiment in which an optically anisotropic layer further comprises cellulose ester, an embodiment in which an orientation layer is formed between an optically anisotropic layer and a transparent support and an embodiment in which a transparent support of an optical compensation film having an optically anisotropic layer is optically negatively uniaxial, which has an optical axis in the direction of the normal line of the transparent support and which further satisfies the following condition.

20={(nx+ny)/2−nz}×d=400

In the above conditional equation, nx represents a refractive index in the slow axis direction in the film plane (the direction in which the refractive index is the maximum), ny represents a refractive index in the fast axis direction in the film plane (the direction in which the refractive index is the minimum), nz represents a refractive index in the film thickness direction, and d represents the thickness of the optical compensation layer.

A polarizing plate having an antireflection film can be applied to image display devices such as liquid crystal display devices (LCD) and electroluminescence displays (ELD).

A polarizing plate having an antireflection film of the present invention as shown in FIG. 3 is used after being bonded to the glass of liquid crystal cells directly or via another layer.

A polarizing plate having an antireflection film can be suitably used for transmissive, reflective or semi-transmissive liquid crystal display devices of a twisted nematic (TN), super twisted nematic (STN), vertical alignment (VA), in-plane switching (IPS) or optically compensated bend cell (OCB) mode.

Further, when the above polarizing plate is used for transmissive or semi-transmissive liquid crystal display devices, display devices having a higher visibility can be obtained using together a commercially available film with improved brightness (a polarization splitting film having a polarization selecting layer, e.g., D-BEF available from Sumitomo 3M Limited).

The polarizing plate can also be used as a polarizing plate for a reflective liquid crystal display or a surface protection board for an organic EL display in combination with a λ/4 plate so as to reduce reflected light on the surface and from the inside.

Next, the production method of an optical film which employs the production line for optical film illustrated in FIG. 1 will be explained. First, a 40 to 300 μm thick web 16, on which a polymer layer has been formed, is fed out from a feeder 66. The web 16 is guided by guide rollers 68 and fed into a duster 74, whereby dust adhered to the surface of the web 16 is removed. A coating solution is then coated onto the web 16 by a gravure coating apparatus 100.

Once coating has been finished, the web is passed through a drying zone 76 and a heating zone 78, to thereby form a coated film. This coated film is irradiated with ultraviolet rays by an ultraviolet irradiation apparatus 50, whereby a desired polymer is formed by causing the liquid crystal to cross-link. At this stage the curing conditions for the coated film can be controlled within an optimal range, since the oxygen concentration in the enclosed space interior which is formed by the housing 52 is controlled at a low level. This allows the quality of the coated layer, especially scratch resistance, adhesion and the like, to be improved.

The housing 52 oxygen concentration is preferably controlled to be no greater than 2%, more preferably no greater than 0.5%, and even more preferably no greater than 0.05%.

The web 16 on which this polymer has been formed is wound up by a winder 82.

In the configuration according to the present embodiment, two ultraviolet lamp houses 54, 54 are provided. Nitrogen gas is fed not only into the housing 52 located between the ultraviolet lamp house 54 and the web 16 opposite thereto, but also fed onto the surface of the web 16 located between the ultraviolet lamp houses 54, 54.

Thus, not only is the portion of the web 16 located opposite the ultraviolet lamp house 54 enclosed within the enclosed space, but also is the periphery of the web 16 located between the ultraviolet lamp houses 54, 54, whereby the curing conditions for the coated film can be controlled within an optimal range.

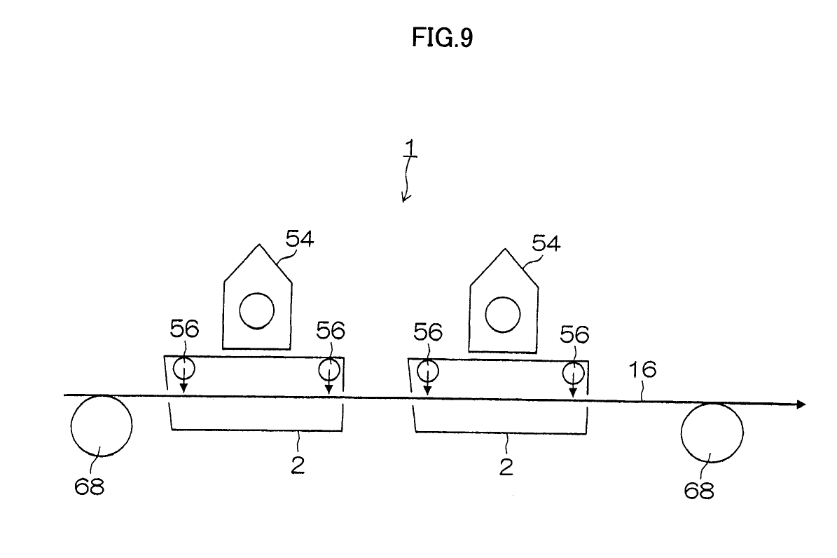

Below a comparison will be made between the configuration according to the present embodiment and a configuration (hereinafter referred to as “conventional configuration”) wherein two ultraviolet lamp houses 54, 54 are provided, but nitrogen gas is fed only into the space between an ultraviolet lamp house 54 and the web 16 opposite thereto. This conventional configuration will be described with reference to FIG. 9.

In the conventional configuration, after the web has been irradiated with ultraviolet rays by the first ultraviolet lamp house, the web is then immediately exposed to an atmosphere containing approximately 20% oxygen. It is thought that this hinders polymerization of the resin in which the reaction is still proceeding (the reaction has not yet finished). It is also thought that oxygen adheres merely to the surface of the coated film (resin) as a result of the air layer, whereby polymerization is hindered during curing. It is believed that the oxygen concentration on the mere surface of this coated film is slightly higher than the average oxygen concentration in the casing, since the oxygen is not easily substituted by an inert gas due to the boundary layer.

In contrast, the configuration according to the present embodiment not only encloses the portion of the web 16 located opposite the ultraviolet lamp house 54 within the enclosed space, but also encloses the periphery of the web 16 located between the ultraviolet lamp houses 54, 54, whereby the oxygen concentration in this enclosed space can be maintained at a predetermined (low) level. Thus, there is no such hindrance of polymerization during curing.

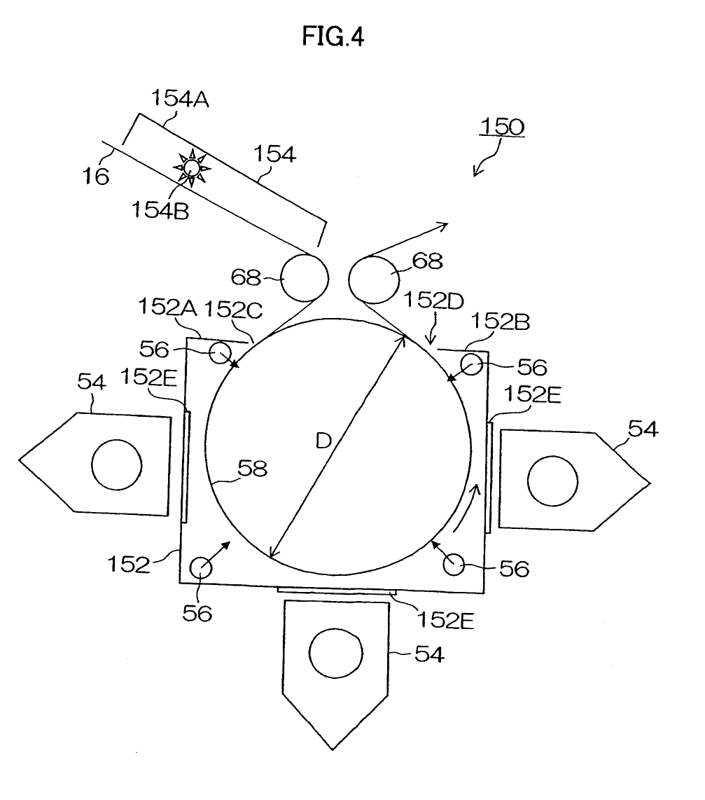

Next, a second aspect according to the present invention will be explained. FIG. 4 is a cross-sectional view illustrating the configuration of an ultraviolet irradiation apparatus 150 employed in the second aspect corresponding to FIG. 2 for the first aspect. Differences between the present embodiment and the first embodiment illustrated in FIG. 2 are: that the number of ultraviolet lamp houses 54 is 3; that the web 16 is supported by being wound around a back-up roller (roller element) 58; the structure of the housing 152; and that a preheating zone 154 for the coated film is provided prior to the irradiation apparatus 150.

The preheating zone 154 is a preheating device provided so that the web 16 attains a temperature of 40° C. or more prior to the curing of the coated layer by ultraviolet irradiation. By controlling the temperature of the web 16 in such a manner, the speed with which the cured film curing proceeds can be increased, and removal of oxygen at the boundary layer becomes easier.

This preheating zone 154 comprises a thin square-type housing 154A provided on the surface (upper) side of the web 16 and a heater lamp 154B provided in the housing 154A. It can be noted that as long as the configuration of the preheating zone 154 is such that the web 16 can be controlled to reach 40° C. or more, any of various commonly known configurations may be employed.

The backup roller 58 is a roller element which winds the web 16 around its periphery, whereby the web is supported. The backup roller 58 is rotatably driven by a driving device (not shown) so that its periphery velocity is the same as the transportation velocity of the web 16. In the configuration illustrated in FIG. 4, the web 16 is guided by a guide roller 68 located upstream of the backup roller 58, and wound around the backup roller 58. After being in contact with the backup roller periphery for approximately 330°, the web 16 is guided by a guide roller 68 located downstream of the backup roller 58, and conveyed to the next step.

The diameter D of the backup roller 58 is not particularly restricted, although in the configuration of FIG. 4, a diameter of between 330 and 700 mm is employed. However, it is also possible for the diameter to be one meter or more.

The backup roller 58 has a temperature control device in its interior for controlling the surface temperature to 30° C. or greater. By controlling the surface temperature of the backup roller 58 in such a manner, the rate with which the cured film curing proceeds can be increased, and, removal of oxygen at the boundary layer becomes easier.

As the specific configuration of the temperature controlling device, a configuration wherein a fluid (water, oil etc.) is circulated in the backup roller 58 is often employed. In addition, a configuration wherein the backup roller 58 acts as a dielectric heating roller can also be employed.

The housing 152, whose cross-section is an approximately U-shaped covering, covers the outer periphery of the backup roller 58, and serves to form an enclosed space in the interior. Further, horizontal overhanging members 152A, 152B are provided so as to extend into the U-shaped from both of the upper ends thereof, whereby the interior sealability is improved. That is, elongated slits 152C and 152D are respectively formed in a width direction (perpendicular direction to the paper surface) of the web 16 in the space between these overhanging members 152A, 152B and the surface of the backup roller 58.

Lamp houses 54, 54, 54 are provided opposite to the three peripheral surfaces of the housing 152 so that ultraviolet rays can be irradiated onto the coated film of the web 16 surface wound onto the backup roller 58. Therefore, the portion in the housing 152 which is opposite to the ultraviolet lamp house 54 is formed from a highly UV-permeable transparent substrate 152E, whereby the ultraviolet rays irradiated from the ultraviolet lamp house 54 can be efficiently irradiated onto the coated film of the web 16. Quartz glass, for example, can be preferably utilized as the transparent substrate 152E.

Thus, because the housing 152 and the ultraviolet lamp house 54 are configured separately, the housing 152 is less susceptible to the effects (e.g. thermal deformation) of the ultraviolet lamp house 54.

Nozzles 56, 56, . . . are provided in the four corners of the housing 152 interior. These nozzles 56 are devices for feeding nitrogen gas into the enclosed space of the housing 152 interior, whereby nitrogen gas fed from gas pipes (not shown) is ejected in the direction of the arrows shown in the figure.

The interior of the housing 152 is further provided with the probe of an oxygen concentration meter (not shown). By using such a configuration, the housing 152 interior can be turned into an enclosed space, and by feeding an inert gas such as nitrogen gas, the oxygen concentration can be controlled to a desired value.

Next, a method for producing an optical film which employs the ultraviolet irradiation apparatus 150 illustrated in FIG. 4 will be explained. The steps illustrated in FIG. 1 from the feeder 66 to the heating zone 78 are identical with the first aspect, and their explanation is omitted here.

Ultraviolet rays are irradiated onto a coated film with the ultraviolet irradiation apparatus 150 illustrated in FIG. 4, whereby a desired polymer is formed by causing the liquid crystal to cross-link. At this stage nitrogen gas is ejected into the housing 152 interior from nozzles 56, 56, . . . located in the four corners of the housing 152 so that the oxygen concentration in the enclosed space formed by the housing 152 decreases. The ejected nitrogen gas is discharged to the exterior via slits 152C and 152D.

Thus, since the oxygen concentration in the housing 152 interior is controlled to a desired value, the curing conditions for the coated film can be controlled within an optimal range, thereby allowing the quality of the coated layer, especially scratch resistance, adhesion and the like, to be improved.

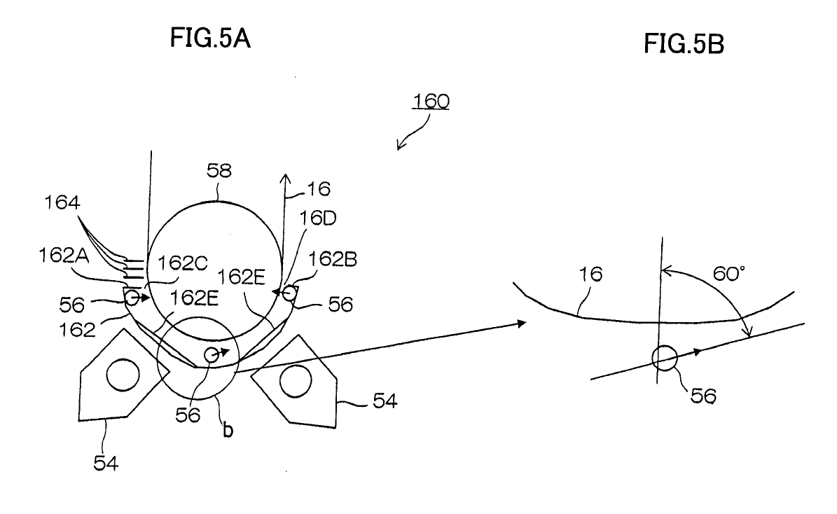

Next, a third aspect according to the present invention will be explained. FIG. 5A is a cross-sectional view illustrating the configuration of an ultraviolet irradiation apparatus 160 employed in the third aspect, corresponding to FIG. 2 for the first aspect and FIG. 4 for the second aspect. FIG. 5A is a general view of the ultraviolet irradiation apparatus 160, and FIG. 5B is an enlarged view showing the insides of the circle b of FIG. 5A. Elements which are the same or similar to what is disclosed in FIGS. 1, 2 and 4 are denoted with the same numerals, and their detailed explanation here is omitted.

Differences between the third aspect and the second aspect illustrated in FIG. 4 are: that the number of ultraviolet lamp houses 54 is two; that the angle which the web 16 winds around the back-up roller 58 is 180′; the structure of the housing 162; and that a preheating zone for the coated film is not provided prior to the irradiation apparatus 160.

The housing 162, whose cross-section is a generally semicircular shape covering, covers the outer periphery of the backup roller 58, and serves to form an enclosed space in the interior. Further, horizontal overhanging members 162A, 162B are provided so as to extend to the inside from both of the upper ends of the housing 162, whereby the interior sealability is improved. That is, elongated slits 162C and 162D are respectively formed in a width direction (perpendicular direction to the paper surface) of the web 16 in the space between these overhanging members 162A, 162B and the surface of the backup roller 58.

Lamp houses 54, 54 are provided opposite to the periphery of the housing 162 so that ultraviolet rays can be irradiated onto the coated film of the web 16 surface wound onto the backup roller 58. Therefore, the portion in the housing 162 which is opposite to the ultraviolet lamp house 54 is formed from a transparent substrate 162E which is highly transmissive to ultraviolet rays, whereby the ultraviolet rays irradiated from the ultraviolet lamp house 54 can be efficiently irradiated onto the coated film of the web 16. Quartz glass, for example, can be preferably utilized as the transparent substrate 162E.

Nozzles 56, 56, 56 are provided in three places of the housing 162 interior. These nozzles 56 are devices for feeding nitrogen gas into the enclosed space of the housing 162 interior, whereby nitrogen gas fed from gas pipes (not shown) is ejected in the direction of the arrows shown in the figure.

Among these nozzles, the nitrogen gas injection direction of the center nozzle 56 is arranged so as to be at an angle of between 0 to 90° of the traveling direction of the web 16. In FIGS. 5A and 5B, this angle is set at 30° (supplementary angle of 60° to that shown in the figure).

The interior of the housing 152 is further provided with the probe of an oxygen concentration meter (not shown). By using such a configuration, the housing 162 interior can be turned into an enclosed space, and by feeding an inert gas such as nitrogen gas, the oxygen concentration can be controlled to a desired value.

Upstream of the inlet side (slit 162C) of the housing 162, three wind shielding boards 164, 164, 164 are provided at fixed intervals parallel to the overhanging member 162A. These wind shielding boards 164 are elongated plate-shaped members arranged in a width direction (perpendicular direction to the paper surface) of the web 16. The distance between a wind shielding board 164 close to the slit 162C and the overhanging member 162A is preferably less than 10 mm. The wind shielding boards 164 are provided opposite to the web 16, wherein the gap with the web 16 is preferably no greater than 5 mm.

Thus, by providing a wind shielding board 164, inflow of air into the enclosed space can be further prevented, whereby it becomes easy to control the oxygen concentration to the desired value. This is also suitable for suppressing the amount of inert gas used.

Next, a method for producing an optical film which employs the ultraviolet irradiation apparatus 160 illustrated in FIGS. 5A and 5B will be explained. The steps illustrated in FIG. 1 from the feeder 66 to the heating zone 78 are identical with the first aspect, and their explanation is omitted here.

Ultraviolet rays are irradiated onto a coated film with the ultraviolet irradiation apparatus 160 illustrated in FIGS. 5A and 5B, whereby a desired polymer is formed by causing the liquid crystal to cross-link. At this stage nitrogen gas is ejected into the housing 162 interior from nozzles 56, 56, 56 of the housing 162 so that the oxygen concentration in the enclosed space formed by the housing 162 decreases. The ejected nitrogen gas is discharged to the exterior via slits 162C and 162D.

In particular, since the oxygen concentration of the housing 162 interior can be controlled to a desired value due to the injection of nitrogen gas on the downstream side of the center nozzle 56, and, the configuration of wind shielding boards 164, the curing conditions for the coated film can be controlled within an optimal range, which allows the quality of the coated layer, especially scratch resistance, adhesion and the like, to be improved.

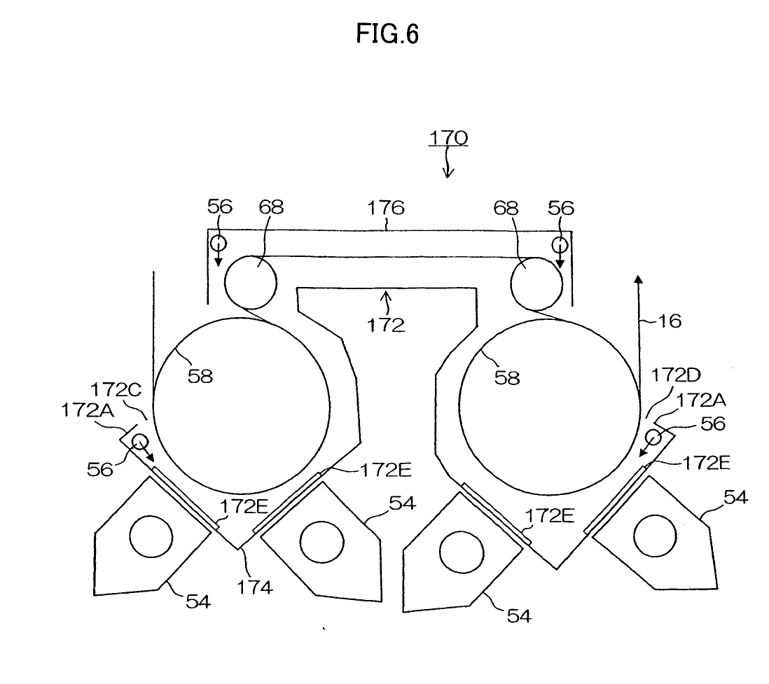

Next, a fourth aspect according to the present invention will be explained. FIG. 6 is a cross-sectional view illustrating the configuration of an ultraviolet irradiation apparatus 170 employed in the fourth aspect, corresponding to FIG. 2 for the first aspect, FIG. 4 for the second aspect and FIGS. 5A and 5B for the third aspect. Elements which are the same or similar to what is disclosed in FIGS. 1, 2, 4 and 5 are denoted with the same numerals, and their explanation here is omitted.

The difference between the fourth aspect and the third aspect illustrated in FIGS. 5A and 5B lies mainly in the configuration of the housing 172. This housing 172 has a configuration in which two of the housings 162 of the third aspect illustrated in FIGS. 5A and 5B are connected together. Two lamp houses 54 are provided opposite each of the backup rollers 58 (total of four houses) provided in the respective housing.

This housing 172, whose cross-section forms an approximately upwards-facing Σ shape, is constituted from a housing body 174 formed so as to enclose two backup rollers 58 and a cover 176 which covers the traveling path formed between the guide rollers 68, 68 from the opposite side of the housing body 174.

Other parts of the configuration are not that much different from the ultraviolet irradiation apparatus 160 of the third aspect illustrated in FIGS. 5A and 5B, and their detailed explanation is omitted here. In addition, the method for producing an optical film which employs the ultraviolet irradiation apparatus 170 illustrated in FIGS. 5A and 5B is also not that different from that of the ultraviolet irradiation apparatus 160, and a detailed explanation is omitted here.

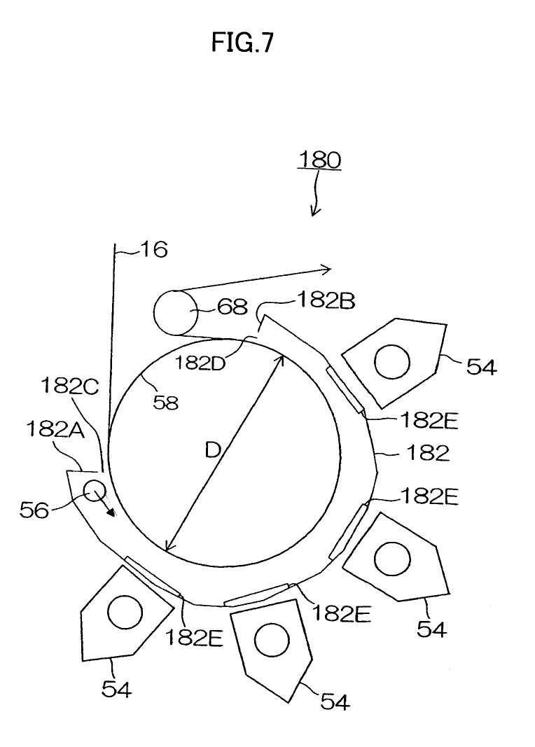

Next, a fifth aspect according to the present invention will be explained. FIG. 7 is a cross-sectional view illustrating the configuration of an ultraviolet irradiation apparatus 180 employed in the fifth aspect, corresponding to FIG. 2 for the first aspect, FIG. 4 for the second aspect, FIGS. 5A and 5B for the third aspect and FIG. 6 for the fourth aspect. Elements which are the same or similar to what is disclosed in FIGS. 1, 2, 4, 5 and 6 are denoted with the same numerals, and their explanation here is omitted.

The fifth aspect differs from the second aspect illustrated in FIG. 4 in that the number of ultraviolet lamp houses 54 is four; the housing 182 has a different structure; the nozzles 56 is differently placed; and a preheating zone 154 for the coated film is not provided prior to the irradiation apparatuses 150.

The housing 182 has a shape which follows that of the backup roller 58, thereby acting as a cover which forms an enclosed space between the backup roller 58 and the housing 182. That is, the housing 182 has a circular cross-section which is notched in some parts, and covers approximately 270° of the periphery of the backup roller 58.

The nozzle 56 in the housing 182 interior is positioned at the most upstream side, i.e. at the rear of the overhanging member 182A, so as to inject nitrogen gas in the direction of the arrow illustrated in FIG. 7. Therefore, according to this configuration a constant nitrogen gas flow from the upstream side to the downstream side can be formed. The nitrogen gas is discharged to the exterior from the slit 182D.

Other parts of the configuration are not that much different from the ultraviolet irradiation apparatus 150 of the second aspect illustrated in FIG. 4 and the ultraviolet irradiation apparatus 170 of the fourth aspect illustrated in FIG. 6, and their detailed explanation is omitted here. In addition, the method for producing an optical film which employs the ultraviolet irradiation apparatus 180 illustrated in FIG. 7 is also not much different from that of the other ultraviolet irradiation apparatuses 150, 160 and 170, and a detailed explanation is omitted here.

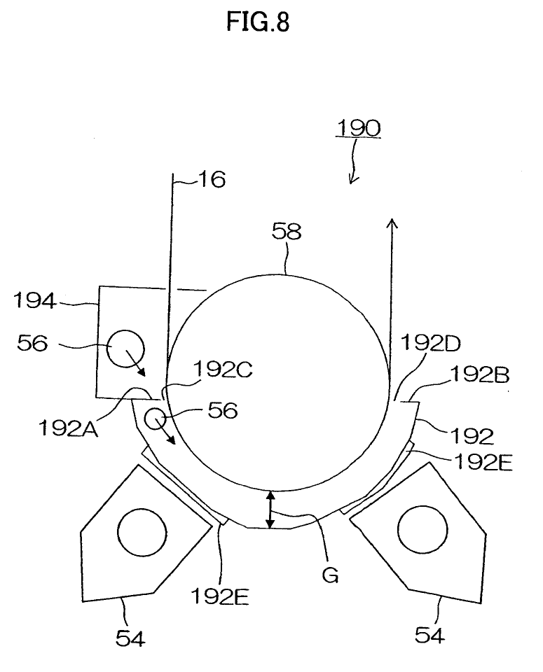

Next, a sixth aspect according to the present invention will be explained. FIG. 8 is a cross-sectional view illustrating the configuration of an ultraviolet irradiation apparatus 190 employed in the sixth aspect, corresponding to FIG. 2 for the first aspect, FIG. 4 for the second aspect, FIGS. 5A and 5B for the third aspect, FIG. 6 for the fourth aspect and FIG. 7 for the fifth aspect. Elements which are the same or similar to what is disclosed in FIGS. 1, 2, 4, 5, 6 and 7 are denoted with the same numerals, and their explanation here is omitted.

Differences between the sixth aspect and the third aspect illustrated in FIGS. 5A and 5B are: the placement of the nozzles 56; and the fact that a prechamber 194 is provided in place of the wind shielding boards 164, 164, 164. Thus, the prechamber 194 is provided upstream of the inlet side (slit 192C) of the housing 192 and a nozzle 56 is provided in the prechamber 194, whereby nitrogen gas is ejected towards the slit 192C from the nozzle 56 in the interior of this prechamber 194.

The nozzles 56 in the housing 192 interior is positioned in the same manner as in the fifth aspect illustrated in FIG. 7, whereby a constant nitrogen gas flow from the upstream side to the downstream side can be formed. The nitrogen gas is discharged to the exterior from the slit 192D.

It is preferable to feed the nitrogen gas from the nozzle 56 located in the prechamber 194. The oxygen concentration can be easily controlled to a desired value as a result of the nitrogen gas being ejected from a prechamber configured in this manner. This is also suitable for suppressing the amount of inert gas which is used.

Like the first aspect illustrated in FIG. 2, the distance G between the upper face of the transparent substrate 192E and the coated film of the web 16 is no greater than 50 mm. According to such a configuration, the oxygen in the case can be rapidly purged, whereby controlling the oxygen concentration to a desired value becomes easy. This is also suitable for suppressing the amount of inert gas which is used. Other parts of the configuration are not that much different from the ultraviolet irradiation apparatus of the respective aspects illustrated in the respective figures, and their detailed explanation is omitted here. In addition, the method for producing an optical film which employs the ultraviolet irradiation apparatus 190 illustrated in FIG. 8 is also not much different from that of the ultraviolet irradiation apparatuses 150, 160, 170 and 180, and a detailed explanation is omitted here.

In the above, aspects relating to the curing method and apparatus of a coated film and an optical film according to the present invention have been explained. However, the present invention is not limited to the above-described embodiments, and various other embodiments can also be employed.

For example, although nitrogen was used in each of aspects according to the present invention mainly for the operational cost, other inert gases (carbon dioxide or a noble gas) may also be used.

Further, although production of an optical film was mainly described, the present invention is not limited to this, and can be applied to any active ray curable resin which requires hardness.

### EXAMPLES

### Example 1

Using the production line 10 for optical film illustrated in FIG. 1 and the ultraviolet irradiation apparatus 50 illustrated in FIG. 2, a coating solution was coated and then cured. The controllability of the oxygen concentration in the enclosed space interior was evaluated.

A light-diffusing hard coating solution was produced by dissolving 75 g of a mixture of dipentaerythritol pentaacrylate and dipentaerythritol hexaacrylate (DNPA, manufactured by Nippon Kayaku Co., Ltd.) and 240 g of hard coating solution containing a dispersion of zirconium oxide ultrafine particles having a particle size of about 30 nm (DeSolite Z-7401, manufactured by JSR Corporation) in 52 g of a mixed solvent of methyl ethyl ketone/cyclohexanone (54/46% by weight). The obtained solution was charged with 10 g of a photopolymerization initiator (Irgacure 907, manufactured by Ciba Specialty Chemicals Inc.), which was dissolved under stirring. This resulting solution was then charged with 0.93 g of a fluorine surfactant (Megafac F-176 PF, manufactured by Dainippon Ink and Chemicals Inc.) consisting of 20% by weight a fluoride-containing oligomer in methyl ethyl ketone solution. (The refractive index of the coated film obtained by coating this solution and then subjecting the coated solution to ultraviolet curing was 1.65.) The resulting solution was charged with 29 g of a dispersed solution obtained by dissolving 20 g of crosslinked polystyrene particles (SX-200HS manufactured by Soken Chemical & Engineering Co., Ltd.) having an average particle size of 2.0 μm and a refractive index of 1.61 in 80 g of a mixed solvent consisting of methyl ethyl ketone/cyclohexanone (54/46% by weight) while stirring for one hour at 5,000 rpm by high speed dispersion, then filtering the dispersed solution with polypropylene filters having a pore size of 10 μm, 3 μm and 1 μm (all manufactured by Fuji Photo Film Co., Ltd.). This resulting solution was stirred, and then filtered with a polypropylene filter having a pore size of 30 μm, whereby a coating solution for an anti-glare layer were prepared.

The viscosity and surface tension of the coating solution was set to 0.007 N·s/m² and 0.033 Nm. As the web 16, a TAC manufactured by Fuji Photo Film Co., Ltd. having a 80 μm thickness and 1,540 mm width was run. Coating was carried out by setting the web 16 transportation velocity to 30 m/min and using a gravure coater to adjust the film thickness during coating to 5 μm (coating amount of 5 mL/m²). The coating rate was set at 30 m/min.

As the ultraviolet lamp house 54 (UV apparatus), an air-cooled metal halide lamp (120 w/cm) (manufactured by Eye Graphics Co., Ltd.) was used. The interval between the ultraviolet lamp houses 54, 54 was 800 mm.

The slit width of the housing 52 inlet side slit 52C and outlet side slit 52D was 10 mm, and the slit length was 1,700 mm. The total thickness of the housing 52 was 150 mm. The distance from the housing 52 inlet side slit 52C to the first ultraviolet lamp house 54 irradiation member was 150 mm. The distance from the housing 52 outlet side slit 52D to the second ultraviolet lamp house 54 irradiation member was 150 mm.

The periphery of the transparent plates 52E, 52E provided on the housing 52 was sealed by a heat resistant sealant.

As the inert gas, 99.999% pure nitrogen gas was used, whereby nitrogen gas was perpendicularly ejected onto the web 16 across the approximately 1,700 mm width in a width direction of the web 16 from each of the inlet upper portion, middle portion and outlet upper portion nozzles 56 of the housing 52 interior.

The oxygen concentration was measured at the film surface in the center of the housing film 52 interior.

As a comparative example, the above-described conventional ultraviolet irradiation apparatus 1 illustrated in FIG. 9 was used. This ultraviolet irradiation apparatus 1 comprised two ultraviolet lamp houses 54, 54, but nitrogen gas was fed from the housing 2 only between ultraviolet the lamp houses 54 and the web 16 opposite thereto. Thus, this ultraviolet irradiation apparatus 1 had a configuration wherein a nozzle 56 was provided in respectively the inlet and the outlet of the housing 2. The lengths of the housings 2 of the ultraviolet lamp houses 54 were 300 mm each.

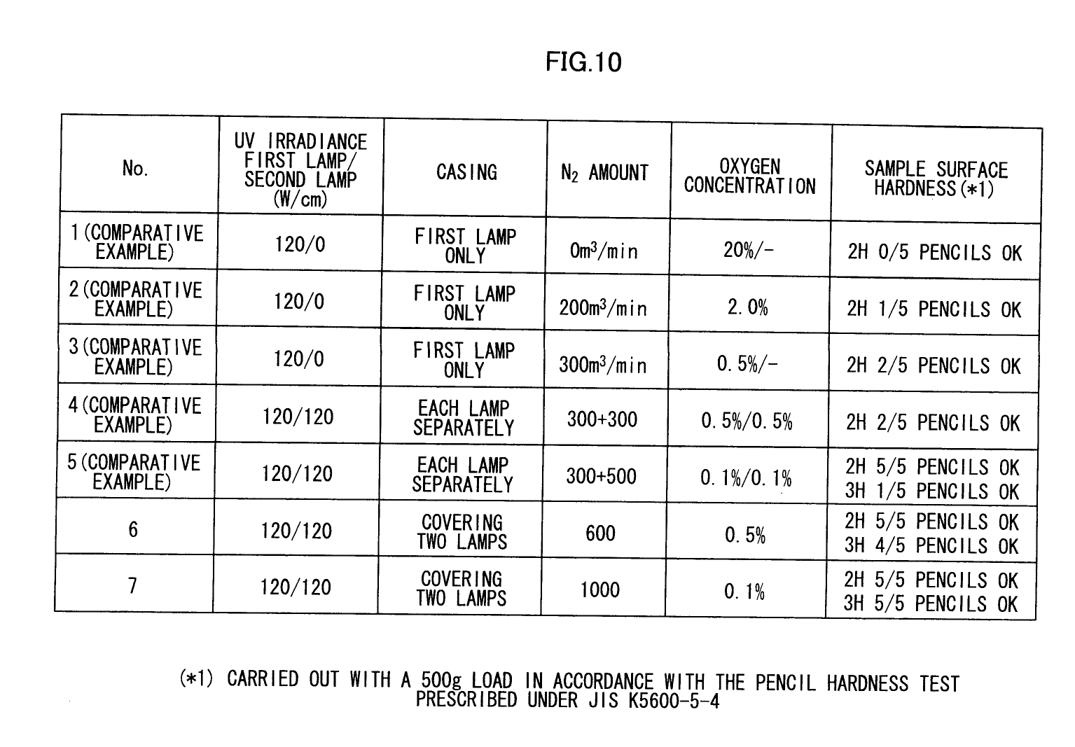

The curing treatments in Comparative Examples 1 to 4 and Examples 5 and 6 were conducted by varying the illuminance of the ultraviolet lamp houses 54 and flow amount of the fed nitrogen gas. The oxygen concentrations at this stage were measured, and the hardness of the coated films was evaluated in accordance with the pencil hardness test (load 500 g) prescribed under JIS K5600-5-4. The conditions and results are given in a table of FIG. 10.

From the table, it was learned that in the present embodiment, wherein two lamps were covered and oxygen exposure was not performed midway through, the surface hardness of the samples (coated films) was harder than that for the conventional examples. It was further learned that a lower oxygen concentration leads to a higher surface hardness.

### Example 2

Using the production line 10 for optical film illustrated in FIG. 1 and the ultraviolet irradiation apparatus 50 illustrated in FIG. 2, a coating solution was coated and then cured. The controllability of the oxygen concentration in the enclosed space interior was evaluated. The same coating solution as that of Example 1 was used. The diameter D of the backup roller 58 was 1,000 mm, and the open width of the slits 152C and 152D was 3 mm. The coating rate was 30 m/min.

For condition 2, the distance from the housing 52 inlet side slit 52C to the first ultraviolet lamp house 54 irradiation member was 150 mm. The distance from the housing 52 outlet side slit 52D to the second ultraviolet lamp house 54 irradiation member was 250 mm.

For condition 3, the distance from the housing 52 inlet side slit 52C to the first ultraviolet lamp house 54 irradiation member was 150 mm. The distance from the housing 52 outlet side slit 52D to the second ultraviolet lamp house 54 irradiation member was 500 mm.

In condition 1 (Comparative Example), the length of the housing 2 of the ultraviolet lamp house 54 illustrated in FIG. 9 was 300 mm.

As the inert gas, 99.999% pure nitrogen gas was used, whereby nitrogen gas was perpendicularly ejected onto the web 16 across the approximately 1,700 mm width in a width direction of the web 16 from the nozzles 56 located in the four corners of the housing 152 interior.

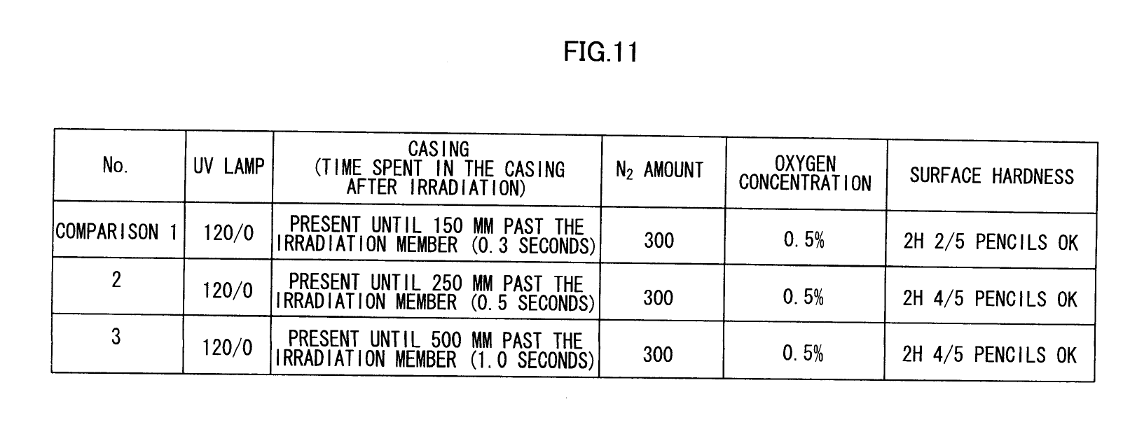

Curing was carried out in Comparative Example 1 and Examples 2 and 3, and the oxygen concentrations at this stage were measured. The hardness of the coated films was evaluated in accordance with the pencil hardness test (load 500 g) prescribed under JIS K5600-5-4. The conditions and results are given in a table of FIG. 11. In the table, the figures in parentheses show the time that the coated film spent in the housing 152, 2 interior after undergoing ultraviolet irradiation.

From the table, it was learned that in the present embodiment the surface hardness of the samples (coated films) was harder than that for the conventional example.

### Example 3

Using the production line 10 for optical film illustrated in FIG. 1 and the ultraviolet irradiation apparatus 150 illustrated in FIG. 4, the coating solution was coated and then cured. The controllability of the oxygen concentration in the enclosed space interior was evaluated. The same coating solution as that of Example 1 was used. The diameter D of the backup roller 58 was 1,000 mm, and the open width of the slits 152C and 152D was 3 mm.

As the inert gas, 99.999% pure nitrogen gas was used, whereby nitrogen gas was perpendicularly ejected onto the web 16 across the approximately 1,700 mm width in a width direction of the web 16 from the nozzles 56 located in the four corners of the housing 152 interior.

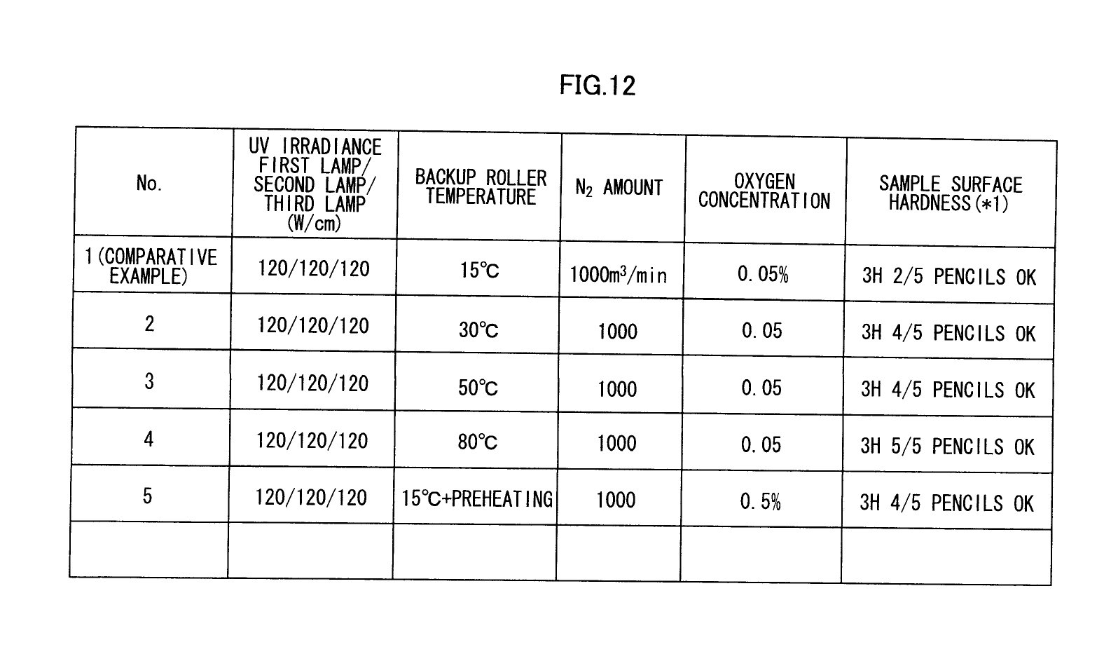

The curing treatments in Comparative Example 1 and Examples 2 to 5 were conducted by varying the illuminance of the ultraviolet lamp houses 54 and the surface temperature of the backup rollers 58. The oxygen concentrations at this stage were measured and the hardness of the coated films was evaluated in accordance with the pencil hardness test (load 500 g) prescribed under JIS K5600-5-4. The conditions and results are given in a table of FIG. 12.

From the table, it was learned that in the present embodiment, in which the surface temperature of the backup roller 58 is controlled to 300° C. or more, or in which preheating is performed, the surface hardness of the samples (coated films) was harder than that for the conventional example.

### Example 4

Using the production line 10 for optical film illustrated in FIG. 1 and the ultraviolet irradiation apparatus 160 illustrated in FIG. 4, the coating solution was coated and then cured. The controllability of the oxygen concentration in the enclosed space interior was evaluated. The same coating solution as that of Example 1 was used. The diameter D of the backup roller 58 was 500 mm, and the distance G between the upper surface of the transparent plate 162E and the coated film on the web 16 was 50 mm or less. The surface temperature of the backup roller 58 was controlled to be 15° C. or more.

As the inert gas, 99.999% pure nitrogen gas was used, whereby nitrogen gas was ejected in the direction shown in the figure onto the web 16 across the approximately 1,700 mm width of the web 16 from the nozzles 56 located in the housing 152 interior.

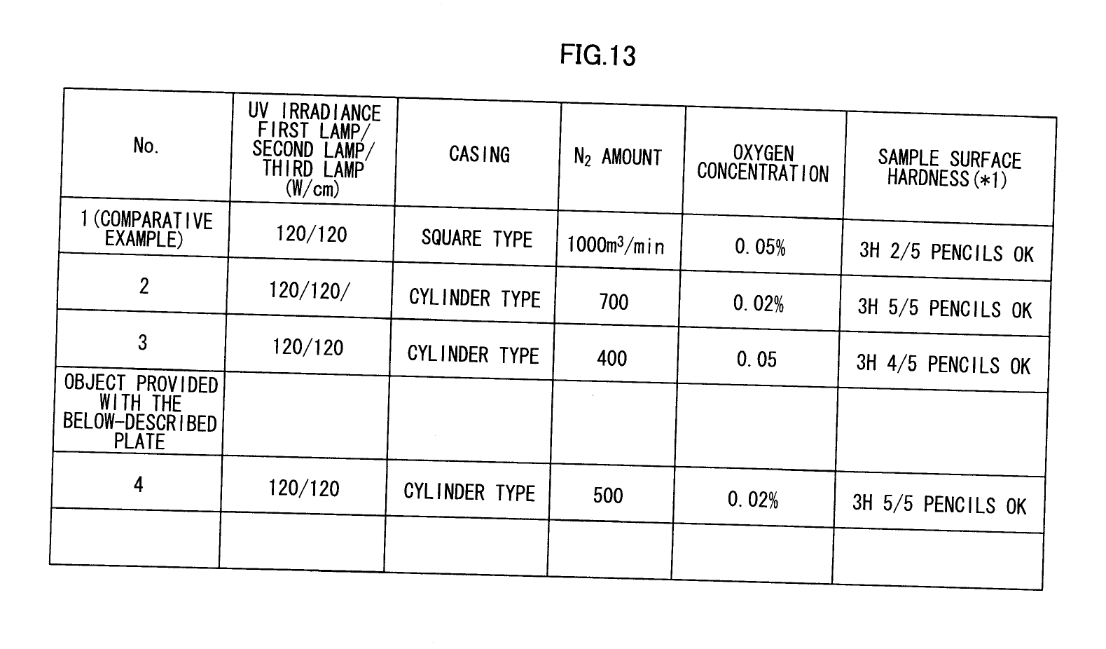

The curing treatments in Comparative Example 1 and Examples 2 to 4 were conducted by varying the illuminance of the ultraviolet lamp houses 54 and the flow amount of the fed nitrogen gas. The oxygen concentrations at this stage were measured and the hardness of the coated films was evaluated in accordance with the pencil hardness test (load 500 g) prescribed under JIS K5600-5-4. The conditions and results are given in a table of FIG. 13.

From the table, it was learned that in the present embodiment the surface hardness of the samples (coated films) was harder than that for the conventional example.

What is claimed is:

1. A method of curing a coated film which includes irradiating an active ray by a plurality of active ray irradiation devices, wherein the coated film is composed of an active ray-curable resin formed on a surface of a running band-shaped flexible support, comprising the steps of:
irradiating the coated film on the surface of the flexible support with an active ray by a first active ray irradiation device, wherein the flexible support is put over a first roller member in a first housing filled with a deoxidized atmosphere to be held at a position where the flexible support is faced with an irradiation surface of the first active ray irradiation device, and
irradiating the coated film on the surface of the flexible support with an active ray by a second active ray irradiation device, wherein the flexible support is put over a second roller member in a second housing filled with a deoxidized atmosphere separated from the first housing to be held at a position where the flexible support is faced with an irradiation surface of the second active ray irradiation device,
wherein the method further comprises maintaining the coated film in a deoxidized atmosphere during a period in which the flexible support is transferred from the first housing to the second housing.

2. The method of curing a coated film according to claim 1, further comprising the steps of:
forming an enclosed space between the first housing to the second housing; and supplying inert gas to the enclosed space.

3. The method of curing a coated film according to claim 1, wherein a device which forms the enclosed space is disposed separately from the active ray irradiation devices.

4. The method of curing a coated film according to claim 1, wherein the first housing and the second housing are arranged in the form of Σ shape.
